(19) United States
(12) Patent Application Publication
(10) Pub. No.: US 2026/0319493 A1
(43) Pub. Date: Oct. 15, 2026

(54) METHOD FOR MAP MODIFICATION, METHOD FOR DEVICE CONTROL, AND APPARATUS FOR MAP MODIFICATION

(71) Applicant: Willand (Beijing) Technology Co., Ltd., Beijing (CN)

(72) Inventors: Bowei ZHAO, Beijing (CN); Tianning Yu, Beijing (CN); Weijie Tang, Beijing (CN); Yansong Zhu, Beijing (CN); Hefeng Han, Beijing (CN); Baoquan Zhang, Beijing (CN); Shuai Li, Beijing (CN); Dong Liu, Beijing (CN); Jiayuan Fu, Beijing (CN); Zichong Chen, Beijing (CN)

(21) Appl. No.: 19/676,992

(22) Filed: May 14, 2026

(30) Foreign Application Priority Data
May 26, 2025 (CN) 202510686818.1
May 26, 2025 (CN) 202510686850.X
May 26, 2025 (CN) 202510688381.5
May 26, 2025 (CN) 202510688404.2
May 26, 2025 (CN) 202510688419.9

(51) Int. Cl. G05D 1/229; A01D 34/00; A01D 101/00; G05D 1/224; G05D 107/20; G05D 109/10; G06F 3/04842; G06F 3/0486

(52) U.S. Cl. CPC G05D 1/2295; A01D 34/008; G05D 1/2246; G06F 3/04842; G06F 3/0486; A01D 2101/00; G05D 2107/23; G05D 2109/10

(57) ABSTRACT

A method for map modification, a method for device control, and an apparatus for map modification are provided. The method for map modification includes: displaying a first virtual map; wherein the first virtual map includes a first virtual boundary, and an area enclosed by the first virtual boundary is used to indicate a working area of an intelligent mobile device; determining endpoints of a boundary segment to be modified in the first virtual boundary, in response to a selection instruction from a user; forming a target virtual boundary segment based on the endpoints and a dragging operation instruction from the user between the endpoints; and determining, based on the target virtual boundary segment and an unmodified boundary segment, a modified second virtual map for display; wherein the unmodified boundary segment is a part of the first virtual boundary other than the boundary to be modified.

### CROSS-REFERENCE TO RELATED APPLICATIONS

This application is filed based on and claims priority to Chinese patent application Nos. 202510688381.5, 202510686818.1, 202510688404.2, 202510688419.9, and 202510686850.X, all filed on May 26, 2025. The contents of the applications are incorporated herein by reference in its entirety for all purposes.

### BACKGROUND

In the related art, a client of an intelligent lawn mower (intelligent mobile device) usually only has a map outline, and only the boundary and shape of the map can be seen. If a user wants to manually adjust the virtual working boundary of the intelligent mobile device in the client, there is no reference position, and the user can only operate arbitrarily based on experience, and the number of adjustable nodes is limited. Mowing according to the virtual boundary of the intelligent mobile device after adjustment still cannot improve the boundary mowing coverage.

### SUMMARY OF THE INVENTION

The present disclosure relates to the technical field of lawn mowers, and specifically, to a method for map modification, a method for device control, and an apparatus for map modification provided by embodiments of the present disclosure.

According to an aspect, there is provided a method for map modification, applied to a client. The method includes: displaying a first virtual map; wherein the first virtual map includes a first virtual boundary, and an area enclosed by the first virtual boundary is used to indicate a working area of an intelligent mobile device; in response to a selection instruction from a user, determining endpoints of a boundary segment to be modified in the first virtual boundary; forming a target virtual boundary segment based on the endpoints and a dragging operation instruction from the user between the endpoints; determining, based on the target virtual boundary segment and an unmodified boundary segment, a modified second virtual map for display; wherein the unmodified boundary segment is the part of the first virtual boundary other than the boundary to be modified.

According to another aspect, there is provided a method for device control, applied to an intelligent mobile device. The method includes: obtaining a second virtual map, and working based on the second virtual map; wherein the second virtual map is determined by a client, in response to a selection instruction from a user for a displayed first virtual map, selecting endpoints of a boundary segment to be modified, and forming a target virtual boundary segment and an unmodified boundary segment based on the endpoints and a dragging operation instruction from the user between the endpoints; the unmodified boundary segment is the part of the first virtual boundary other than the boundary to be modified; the first virtual map includes a first virtual boundary, and an area enclosed by the first virtual boundary is used to indicate a working area of the intelligent mobile device.

According to yet another aspect, there is provided an apparatus for map modification, applied to a client. The apparatus includes: a memory for storing a computer program; and a processor for executing the computer program stored in the memory to: display a first virtual map; wherein the first virtual map includes a first virtual boundary, and an area enclosed by the first virtual boundary is used to indicate a working area of an intelligent mobile device; in response to a selection instruction from a user, determine endpoints of a boundary segment to be modified in the first virtual boundary; form a target virtual boundary segment based on the endpoints and a dragging operation instruction from the user between the endpoints; determine, based on the target virtual boundary segment and an unmodified boundary segment, a modified second virtual map for display; wherein the unmodified boundary segment is the part of the first virtual boundary other than the boundary to be modified.

### DESCRIPTION OF DRAWINGS

FIG. 1 is a first schematic flow diagram of a method for map modification provided by an embodiment of the present disclosure;

FIG. 2 is a first effect schematic diagram of a method for map modification provided by an embodiment of the present disclosure;

FIG. 3 is a second schematic flow diagram of a method for map modification provided by an embodiment of the present disclosure;

FIG. 4 is a third schematic flow diagram of a method for map modification provided by an embodiment of the present disclosure;

FIG. 5 is a second effect schematic diagram of a method for map modification provided by an embodiment of the present disclosure;

FIG. 6 is a third effect schematic diagram of a method for map modification provided by an embodiment of the present disclosure;

FIG. 7 is a fourth effect schematic diagram of a method for map modification provided by an embodiment of the present disclosure;

FIG. 8 is a fifth effect schematic diagram of a method for map modification provided by an embodiment of the present disclosure;

FIG. 9 is a sixth effect schematic diagram of a method for map modification provided by an embodiment of the present disclosure;

FIG. 10 is a seventh effect schematic diagram of a method for map modification provided by an embodiment of the present disclosure;

FIG. 11 is an eighth effect schematic diagram of a method for map modification provided by an embodiment of the present disclosure;

FIG. 12 is a fourth schematic flow diagram of a method for map modification provided by an embodiment of the present disclosure;

FIG. 13 is a ninth effect schematic diagram of a method for map modification provided by an embodiment of the present disclosure;

FIG. 14 is a tenth effect schematic diagram of a method for map modification provided by an embodiment of the present disclosure;

FIG. 15 is an eleventh effect schematic diagram of a method for map modification provided by an embodiment of the present disclosure;

FIG. 16 is a fifth schematic flow diagram of a method for map modification provided by an embodiment of the present disclosure;

FIG. 17 is a twelfth effect schematic diagram of a method for map modification provided by an embodiment of the present disclosure;

FIG. 18 is a sixth schematic flow diagram of a method for map modification provided by an embodiment of the present disclosure;

FIG. 19 is a seventh schematic flow diagram of a method for map modification provided by an embodiment of the present disclosure;

FIG. 20 is an eighth schematic flow diagram of a method for map modification provided by an embodiment of the present disclosure;

FIG. 21 is a thirteenth effect schematic diagram of a method for map modification provided by an embodiment of the present disclosure;

FIG. 22 is a ninth schematic flow diagram of a method for map modification provided by an embodiment of the present disclosure;

FIG. 23 is a fourteenth effect schematic diagram of a method for map modification provided by an embodiment of the present disclosure;

FIG. 24 is a fifteenth effect schematic diagram of a method for map modification provided by an embodiment of the present disclosure;

FIG. 25 is a schematic flow diagram of a method for device control provided by an embodiment of the present disclosure;

FIG. 26 is an interaction schematic diagram of a method for map modification provided by an embodiment of the present disclosure;

FIG. 27 is a structural schematic diagram of an apparatus for map modification provided by an embodiment of the present disclosure;

FIG. 28 is a first schematic diagram of a hardware entity of an electronic device provided by an embodiment of the present disclosure;

FIG. 29 is a structural schematic diagram of a device control apparatus provided by an embodiment of the present disclosure;

FIG. 30 is a second schematic diagram of a hardware entity of an electronic device provided by an embodiment of the present disclosure.

### DETAILED DESCRIPTION

In order to make the purpose, technical solution and advantages of the present disclosure clearer, the technical solution of the present disclosure will be further described in detail below with reference to the accompanying drawings and embodiments. The described embodiments should not be regarded as limiting the present disclosure. All other embodiments obtained by persons of ordinary skill in the art without making creative efforts belong to the protection scope of the present disclosure.

In the following description, “some embodiments” are referred to, which describe a subset of all possible embodiments. However, it can be understood that “some embodiments” may be the same subset or different subsets of all possible embodiments, and can be combined with each other without conflict.

If “first/second” and similar descriptions appear in the application document, the following description is added. In the following description, the terms “first/second/third” are only used to distinguish similar objects and do not represent a specific ordering of the objects. It can be understood that “first/second/third” can be interchanged in a specific order or sequence where permitted, so that the embodiments of the present disclosure described herein can be implemented in an order other than those illustrated or described herein.

Unless otherwise defined, all technical and scientific terms used herein have the same meaning as commonly understood by one of ordinary skill in the art to which this application belongs. The terminology used herein is for the purpose of describing the embodiments of the present disclosure only and is not intended to limit the present disclosure.

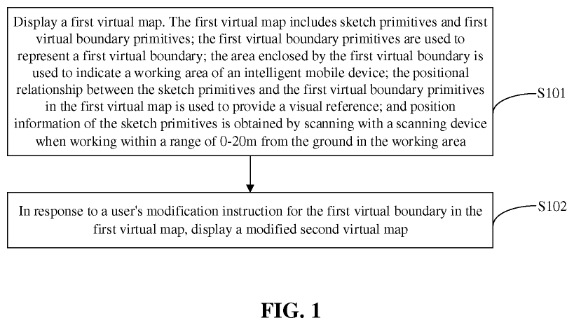

The embodiments of the present disclosure provide a method for map modification. Please refer to FIG. 1, which is a first schematic flow diagram of a method for map modification provided by an embodiment of the present disclosure. The steps shown in FIG. 1 will be described in conjunction with the following:
S101, displaying a first virtual map; wherein the first virtual map includes sketch primitives and first virtual boundary primitives; the first virtual boundary primitives are used to represent a first virtual boundary; the area enclosed by the first virtual boundary is used to indicate a working area of an intelligent mobile device; the positional relationship between the sketch primitives and the first virtual boundary primitives in the first virtual map is used to provide a visual reference; the position information of the sketch primitives is obtained by scanning when a scanning device works within a range of 0-20 m above the ground in the working area.

In the embodiments of the present disclosure, a page of a client displays the first virtual map. The first virtual map may include first virtual boundary primitives representing a first virtual boundary. The first virtual map may also include sketch primitives and first virtual boundary primitives representing a first virtual boundary. The area enclosed by the first virtual boundary in the first virtual map is used to indicate the working area of the intelligent mobile device, that is, the area enclosed by the physical boundary corresponding to the first virtual boundary is the working area of the intelligent mobile device. The sketch primitives and the first virtual boundary primitives are displayed overlapping. The positional relationship between the sketch primitives and the first virtual boundary primitives in the first virtual map is used to provide a visual reference. The scanning device working within a range of 0-20 m above the ground in the working area includes building a map and mowing in the map area, or building a front-to-back yard passage or a passage between a charging station and a boundary, leaving the charging station, or approaching the charging station for charging.

Herein, the position information of the sketch primitives is obtained by scanning by an intelligent lawn mower or a handheld mobile device or an unmanned aerial vehicle. Thus, compared with data downloaded from a map, the position information of the sketch primitives obtained by near-ground scanning is updated in a timely manner, and the data obtained by close-range scanning has high accuracy, thereby enabling the user to adjust the boundary using a timely updated and accurate first virtual map, improving the accuracy of boundary adjustment. When the intelligent mobile device mows using a second virtual map with higher accuracy, the boundary mowing coverage can be improved.

Herein, the scanning device can obtain the position information of the sketch primitives by scanning using one or more of radar, vision and infrared; the positioning sensor of the scanning device includes one or more of Real Time Kinematic (RTK), Inertial Measurement Unit (IMU) and wheel speedometer. Thus, the scanning device obtains the position information of the sketch primitives through multiple sensors, and performs data fusion through multiple positioning sensors, avoiding the data defects caused by using a single sensor, which can improve the accuracy of the sketch primitives, thereby enabling the user to perform boundary adjustment with reference to a more accurate first virtual map, obtaining a virtual boundary with higher accuracy, and improving the boundary mowing coverage.

Herein, the position information of the sketch primitives is obtained by the intelligent mobile device during the mowing stage according to the virtual boundary, or obtained by scanning during the virtual boundary establishing stage. Thus, the sketch primitives can be obtained by the intelligent mobile device anytime and anywhere, which can improve the update frequency of the sketch primitives and prevent inconsistencies between the sketch primitives in the map and the actual sketch primitives. The first virtual map further includes: obstacle primitives; the color of the sketch primitives is different from the color of the obstacle primitives. Thus, the user can accurately distinguish the color of the sketch primitives and the color of obstacles in the first virtual map, thereby accurately adjusting the virtual boundary and obtaining a second virtual map with relatively high accuracy.

Herein, the working stages of the intelligent mobile device include: a virtual boundary establishing stage and a mowing stage according to the virtual boundary; in the virtual boundary establishing stage, the first virtual map is formed by the intelligent mobile device recording multiple position points using a positioning sensor and then performing data processing during the process of moving along the boundary of the working area; in the mowing stage according to the virtual boundary, the working path of the intelligent mobile device along the first virtual boundary includes: a bow-shaped path, a linear path, a rectangular spiral path, a grid-shaped path and a spiral path. Thus, the sketch primitives can also be obtained by the intelligent mobile device anytime and anywhere, which can improve the update frequency of the sketch primitives and prevent inconsistencies between the sketch primitives in the map and the actual sketch primitives.

In the embodiments of the present disclosure, the intelligent mobile device may be an autonomously movable device with certain data acquisition, processing and image acquisition capabilities. In a feasible implementation, the intelligent mobile device may refer to a movable mobile machine device (or mobile robot). The intelligent mobile device may include a garden robot, or may refer to an intelligent lawn mower. In the embodiments of the present disclosure, the intelligent mobile device is described by taking a lawn mower as an example to illustrate the information processing method provided by the present disclosure. It should be noted that the working area may refer to an area where the intelligent mobile device needs to process objects in the area. Exemplarily, the working area may refer to a grassy area or lawn that needs to be trimmed. The sketch primitives may include pixel identifiers of work objects displayed in the working area in the first virtual map. Exemplarily, the sketch primitives may include grass primitives. The work objects may include lawn, contaminated area, or garbage to be cleaned.

In the embodiments of the present disclosure, before displaying the first virtual map, the client can obtain a background map, and under the user's operation, align and overlap the background map and the first boundary map in coordinates to display the first virtual map. The first boundary map includes the first virtual boundary primitives representing the first virtual boundary; the background map includes sketch primitives. The area enclosed by the first virtual boundary is obtained by dividing based on non-work objects of the intelligent mobile device, or is a preset area by the user. Before displaying the first virtual map, the color of each area within the first boundary map is determined based on the color of the background map. The background map may include a lawn point cloud map collected by the lawn mower using a laser radar during processes such as edge following and mowing. Alternatively, it may also include a lawn point cloud map collected by other intelligent devices or people using a laser radar.

In the embodiments of the present disclosure, the area enclosed by the first virtual boundary can be determined in various ways. Exemplarily, the area enclosed by the first virtual boundary can be divided based on non-work objects of the intelligent mobile device. The non-work objects may include roads, buildings, etc. Thus, the working area of the intelligent mobile device can be accurately determined based on the non-work objects of the intelligent mobile device, i.e., the area enclosed by the first virtual boundary can be accurately determined. Exemplarily, the user can also preset the area enclosed by the first virtual boundary, so that the area enclosed by the first virtual boundary meets the actual needs of the user.

In the embodiments of the present disclosure, before displaying the first virtual map, the client can determine the color of each area within the first boundary map based on the color of the background map. The areas within the first boundary map may include a forbidden area, an invalid area, and an area where weeding can be performed. Exemplarily, the color of each area within the first boundary map can be set to a color different from the color of the background map, which is conducive to clearly distinguishing the background map from the areas within the first boundary map in the first virtual map.

In the embodiments of the present disclosure, a first virtual map is displayed in an interactive page; wherein the first virtual map includes a first virtual boundary, a first boundary map includes primitives representing the first virtual boundary, the area enclosed by the first virtual boundary is used to indicate a working area of an intelligent mobile device; a first touch event acting on the first virtual boundary is detected, and a coordinate point in the first boundary map corresponding to the touch point is determined according to the touch point of the first touch event; a preset area containing the coordinate point in the first boundary map is enlarged and displayed at a preset position of the interactive page to obtain a partial enlarged view.

Herein, the first virtual map further includes sketch primitives. The coordinate point is at the center of the partial enlarged view, and the partial enlarged view further includes a portion of the first virtual boundary connected to the coordinate point. The preset area is an area with a first radius length centered at the coordinate point. The enlargement ratio of the partial enlarged view is adjustable. The preset position and the preset area are distributed in different areas of the interactive page. The enlarged area in the partial enlarged view includes a boundary segment to be modified connected to the coordinate point. The boundary segment on the other side connected to the coordinate point that is not selected is not displayed in the partial enlarged view.

Herein, the first virtual map further includes sketch primitives, the position information of the sketch primitives is obtained by scanning when a scanning device works within a range of 0-20 m above the ground in the working area.
S102, in response to a modification instruction from a user for the first virtual boundary in the first virtual map, displaying a modified second virtual map.

In the embodiments of the present disclosure, the client can, in response to the modification instruction from the user for the first virtual boundary in the first virtual map, determine a boundary segment to be modified in the first virtual boundary, and then adjust the boundary segment to be modified according to the user's operation, thereby displaying the second virtual map.

In the embodiments of the present disclosure, on the map editing page, after determining the boundary segment to be modified in response to the modification instruction, the client can adjust the shape and boundary attribute of the boundary segment to be modified according to the user's operation. The boundary attribute is used to indicate the positional relationship between the intelligent mobile device and the first virtual boundary, or the positional relationship between the intelligent mobile device and the first physical boundary corresponding to the first virtual boundary.

In the embodiments of the present disclosure, the lawn mower can first walk along the physical boundary by manual remote control or automatic mode, record multiple position points, and generate a first virtual boundary based on the multiple position points. During the process of establishing the first virtual boundary, the lawn mower continuously scans and records environmental information, which includes grass and non-grass information, forming a boundary local map. Then, according to the range defined by the first virtual boundary, the lawn mower mows in a bow-shaped pattern or other shapes, continuously scanning and recording environmental information, and supplementing this information into the boundary local map to form a global map, i.e., a background map. In summer, mowing is performed about once every 2-3 days. To avoid repeated single-direction rolling, the mowing direction is changed each time, continuously scanning and recording environmental information, and supplementing the environmental information into the global map.

In the embodiments of the present disclosure, on the client map editing page, a first virtual map is displayed; wherein the first virtual map includes a first virtual boundary, the area enclosed by the first virtual boundary being used to indicate a working area of an intelligent mobile device; in response to a selection instruction from a user, a boundary segment to be modified is determined in the first virtual boundary; in response to a boundary attribute type modification instruction from the user for the boundary segment to be modified, the boundary attribute of the boundary segment to be modified is modified to form a second virtual map; wherein the boundary attribute is used to indicate the positional relationship between the intelligent mobile device and the first virtual boundary, or the positional relationship between the intelligent mobile device and a physical boundary corresponding to the first virtual boundary.

In the embodiments of the present disclosure, the first virtual map further displays the range or area information of the sketch primitives, and the physical boundary height information. The lawn mower automatically sets the boundary attribute according to the range or area information of grass and non-grass obtained by the scanning device, and the physical boundary height information. In the embodiments of the present disclosure, the client can also modify different attributes of the first virtual boundary to the same attribute. The boundary attributes include: straddling travel attribute, boundary-inside edge travel attribute, and boundary-outside edge travel attribute; the straddling travel attribute represents that the physical boundary is lower than the chassis of the lawn mower, and there is no dangerous object outside the physical boundary; the boundary-inside edge travel attribute represents that the physical boundary is higher than the chassis of the lawn mower; the boundary-outside edge travel attribute represents that the physical boundary is lower than the chassis of the lawn mower, and the area outside the physical boundary is a grassy area that can be traveled on.

In the embodiments of the present disclosure, on the map editing page, a first virtual map is displayed; wherein the first virtual map includes a first virtual boundary, the area enclosed by the first virtual boundary being used to indicate a working area of an intelligent mobile device; the client, in response to a selection instruction from a user, determines endpoints of a boundary segment to be modified in the first virtual boundary; forms a target virtual boundary segment based on the endpoints and a dragging operation instruction from the user between the endpoints; determines a second virtual map based on the target virtual boundary segment and an unmodified boundary segment; wherein the unmodified boundary segment is the part of the first virtual boundary other than the boundary to be modified.

In the embodiments of the present disclosure, at least a first map style and a second map style are displayed, the color or identification pattern representing grass and non-grass in the first map style is different from that in the second map style, and the first map style and the second map style at least include boundary primitives; a touch event acting on the first map style is detected, then a first virtual map corresponding to the first map style is displayed, the first virtual map including first virtual boundary primitives representing a first virtual boundary, the area enclosed by the first virtual boundary being used to indicate a working area of an intelligent mobile device.

In the embodiments of the present disclosure, upon detecting a touch event acting on a first map style, a background map corresponding to the first map style and a first boundary map are aligned and overlapped in coordinate positions to obtain the first virtual map, the first boundary map including the first virtual boundary primitives; the first virtual map is displayed. In this embodiment, the first boundary map and the background map are displayed on a home page or a map editing page. The color of each area within the first boundary map can be determined based on the color of the background map.

Herein, the first map style is a style that displays the boundary primitives and the background map, and the second map style is a style that displays only the boundary primitives.

Herein, the background map corresponding to the first map style is obtained according to scanning point cloud data obtained by a scanning device working within a range of 0-20 m above the ground in the working area, and/or the first virtual map is obtained according to scanning point cloud data obtained by a scanning device working within a range of 0-20 m above the ground in the working area. The area enclosed by the first virtual boundary is obtained by dividing based on obstacles and grass of the intelligent mobile device, or is a preset area by the user.

In the embodiments of the present disclosure, after forming the second virtual map, the client can directly send or send via a relay device the data of the second virtual map to the intelligent mobile device. After receiving the second virtual map, the intelligent mobile device can work according to the target working area included in the second virtual map.

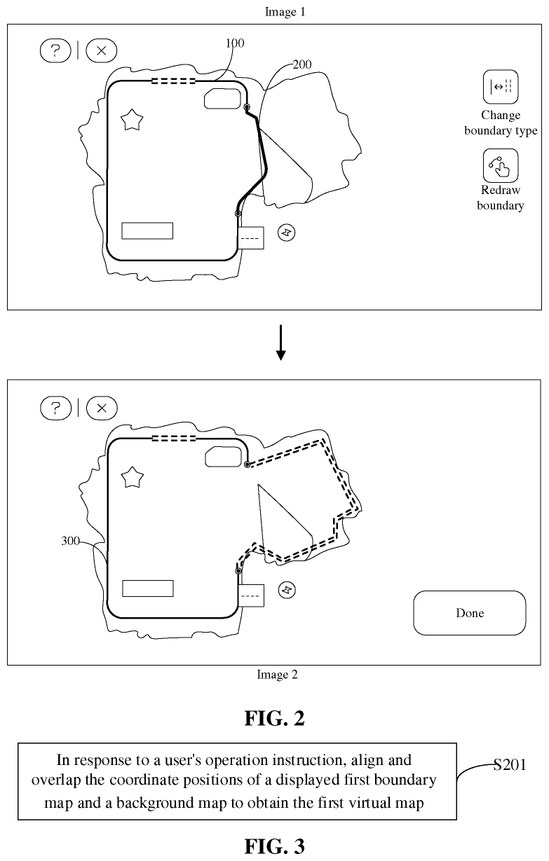

Exemplarily, referring to FIG. 2, image 1 is a schematic diagram of a first virtual map, and image 2 is a schematic diagram of a second virtual map. The irregular line loop in image 1 is a first virtual boundary 100. The user can adjust a boundary segment to be modified 200 in the first virtual boundary 100 to form an adjusted second virtual boundary 300 in image 2, thereby obtaining a second virtual map.

In the embodiments of the present disclosure, by displaying a first virtual map; wherein the first virtual map includes sketch primitives and first virtual boundary primitives representing a first virtual boundary, the area enclosed by the first virtual boundary is used to indicate a working area of the intelligent mobile device; the positional relationship between the sketch primitives and the first virtual boundary primitives in the first virtual map is used to provide a visual reference; the position information of the sketch primitives is obtained by scanning when a scanning device works within a range of 0-20 m above the ground in the working area; in response to a modification instruction from the user for the first virtual boundary in the first virtual map, displaying a modified second virtual map including the modified target working area. Thus, because the positional relationship between the sketch primitives and the first virtual boundary primitives in the first virtual map is used to provide a visual reference for the user, the user can accurately modify and adjust the first virtual boundary according to the positional relationship between the sketch primitives and the first virtual boundary primitives in the first virtual map, thereby obtaining a second virtual map with relatively high boundary accuracy. After the intelligent mobile device works using the second virtual map with relatively high boundary accuracy as a reference, the boundary mowing coverage of the intelligent mobile device can be improved.

Please refer to FIG. 3, which is a second schematic flow diagram of a method for map modification provided by an embodiment of the present disclosure. Description will be made in conjunction with the steps shown in FIG. 3.
S201, in response to an operation instruction from a user, aligning and overlapping the coordinate positions of a displayed first boundary map and a background map to obtain the first virtual map.

In the embodiments of the present disclosure, the first boundary map includes the first virtual boundary primitives representing the first virtual boundary. The client can, in response to the user's operation instruction, align and overlap the coordinate positions of the obtained background map and the first boundary map to obtain the first virtual map for display. The background map includes sketch primitives.

In the embodiments of the present disclosure, if the first virtual boundary in the first virtual map is not completely covered by the sketch primitives, a first prompt is performed to the user after jumping to a predetermined interface; wherein the first prompt is used to remind the user to refer to the sketch primitives when modifying the first virtual boundary. Exemplarily, the first prompt is performed to the user after jumping to a map editing page. Thus, the user can be reminded to accurately adjust the virtual boundary according to the sketch primitives when adjusting the virtual boundary, obtaining a virtual map with relatively high accuracy to provide to the intelligent mobile device, so that the intelligent mobile device can accurately mow according to the actual physical boundary, improving the boundary mowing coverage.

In the embodiments of the present disclosure, if the area of the first virtual boundary in the first virtual map covering the sketch primitives is less than a predetermined ratio, the first prompt is performed to the user after jumping to the predetermined interface. The first predetermined ratio may include 90%. Similarly, the user can be reminded to accurately adjust the virtual boundary according to the sketch primitives when adjusting the virtual boundary, obtaining a virtual map with relatively high accuracy to provide to the intelligent mobile device, so that the intelligent mobile device can accurately mow according to the actual physical boundary, improving the boundary mowing coverage.

Exemplarily, the lawn mower collects lawn point cloud information using a laser radar during processes such as edge following and mowing, and sends it to the client. The client processes the collected point cloud to finally form a lawn aerial view (background map) that truly restores the lawn environment. Then, with the assistance of positioning information, the client accurately superimposes the mowing map boundary (first boundary map) and the lawn aerial view in coordinates, so that the user can adjust the mowing map boundary based on various information displayed on the lawn aerial view through simple human-computer interaction. When entering the map editing page, the system automatically determines the relationship between the mowing map boundary and the lawn aerial view. If the mowing map boundary is not completely within the lawn aerial view, the system prompts the user with relevant information to help the user decide whether to continue using this method for boundary adjustment.

In some other embodiments, the client can, in response to the user's operation instruction, determine the first boundary map as the first virtual map.

In the embodiments of the present disclosure, in response to the user's operation instruction, the coordinate positions of the displayed first boundary map and the background map are aligned and overlapped to obtain the first virtual map. Thus, the first virtual map includes the overlapping displayed sketch primitives and first virtual boundary primitives, and the user can accurately modify and adjust the first virtual boundary according to the positional relationship between the sketch primitives and the first virtual boundary primitives in the first virtual map, thereby obtaining a second virtual map with relatively high boundary accuracy.

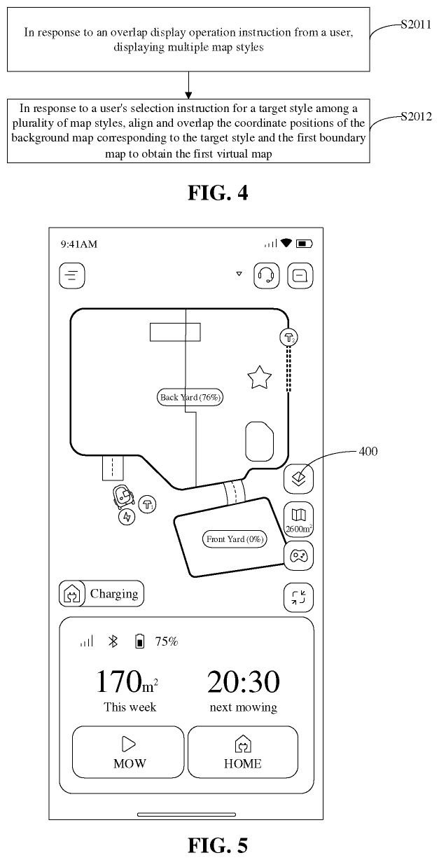

Please refer to FIG. 4, which is a third schematic flow diagram of a method for map modification provided by an embodiment of the present disclosure. S201 in FIG. 3 can also be implemented through S2011 to S2012, which will be described in conjunction with the steps.
S2011, in response to an overlap display operation instruction from a user, displaying multiple map styles.

In the embodiments of the present disclosure, the client can obtain the overlap display operation instruction through a human-computer interaction device, and in response to the overlap display operation instruction, display multiple map styles. Different map styles correspond to different identifications of work objects or non-objects of the intelligent mobile device in the background map.

Exemplarily, the multiple map styles may include: a style displaying only boundary primitives and a style displaying boundary primitives and a background map.

The client can obtain a voice signal through the human-computer interaction device, and the voice signal is the overlap display operation instruction. The client can also obtain a click operation of the user on a corresponding button through the human-computer interaction device, and respond to the click operation to form the overlap display operation instruction.

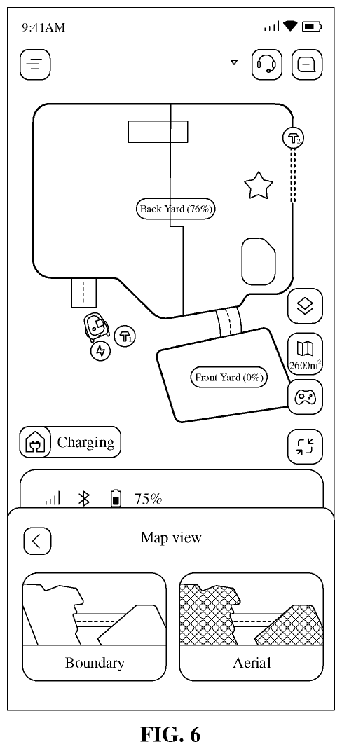

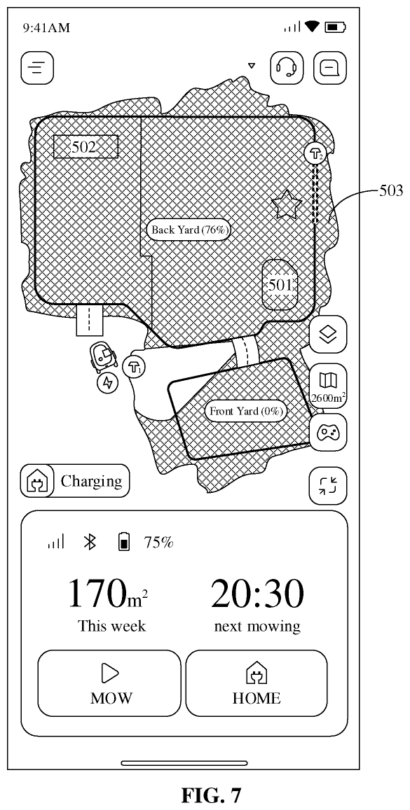

Exemplarily, referring to FIG. 5, which is a home page display diagram of the client. The user can click an overlap display button 400 on the home page, and the client responds to the click operation to display two map styles on the home page. Referring to FIG. 6, these include: a style displaying only the boundary map (boundary) and a style displaying the boundary map and the background map (Aerial). If the user switches from displaying only the boundary to displaying the boundary and a 2D lawn graphic, i.e., the style of FIG. 7, the forbidden area 501, the invalid area 502, and the lawn pattern 503 are all made transparent, which helps the user clearly see the relative positions of these elements.

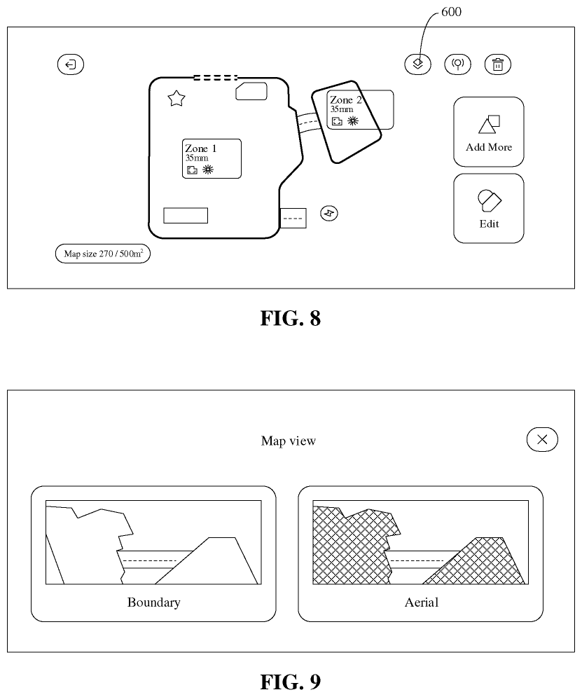

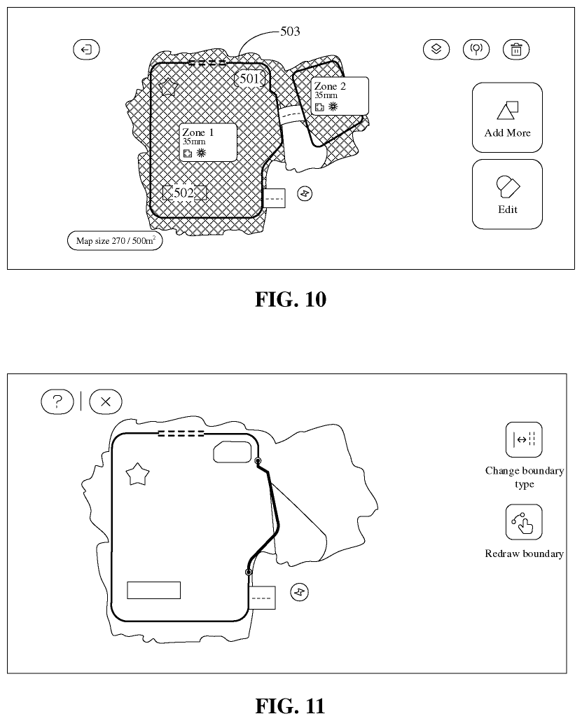

Exemplarily, the client can also generate the first virtual map on the map editing page. Referring to FIG. 8, on the map editing page, the user can click the square overlap icon 600 in the upper right corner to switch the map background style. After clicking the square overlap icon 600 in the upper right corner, FIG. 9 is presented, and the user can switch the desired map style. If the user switches from a background map showing only the map boundary (boundary) to a background map with a 2D map (Aerial), FIG. 10 is displayed, where the forbidden area 501, the invalid area 502, and the lawn pattern 503 are all made transparent, which helps the user clearly see the relative positions of these elements.
S2012, in response to a selection instruction from the user for a target style among the multiple map styles, aligning and overlapping the coordinate positions of the background map corresponding to the target style and the first boundary map to obtain the first virtual map.

In the embodiments of the present disclosure, after the client displays the multiple map styles, when the user wants to display the first virtual map on the client home page, the user can click the target style among the multiple map styles. The client responds to the click on the target style, and aligns and overlaps the coordinate positions of the background map corresponding to the target style and the first boundary map to obtain the first virtual map.

Exemplarily, referring to FIG. 11, it is the first virtual map obtained by the client after aligning and overlapping the coordinate positions of the first boundary map and the background map.

In the embodiments of the present disclosure, in response to the user's overlap display operation instruction, multiple map styles are displayed on the home page. In response to the user's selection instruction for a target style among the multiple map styles, the coordinate positions of the background map corresponding to the target style and the first boundary map are aligned and overlapped to obtain the first virtual map. Thus, the first virtual map includes the overlapping displayed sketch primitives and first virtual boundary primitives, and the user can accurately modify and adjust the first virtual boundary according to the positional relationship between the sketch primitives and the first virtual boundary primitives in the first virtual map, thereby obtaining a second virtual map with relatively high boundary accuracy.

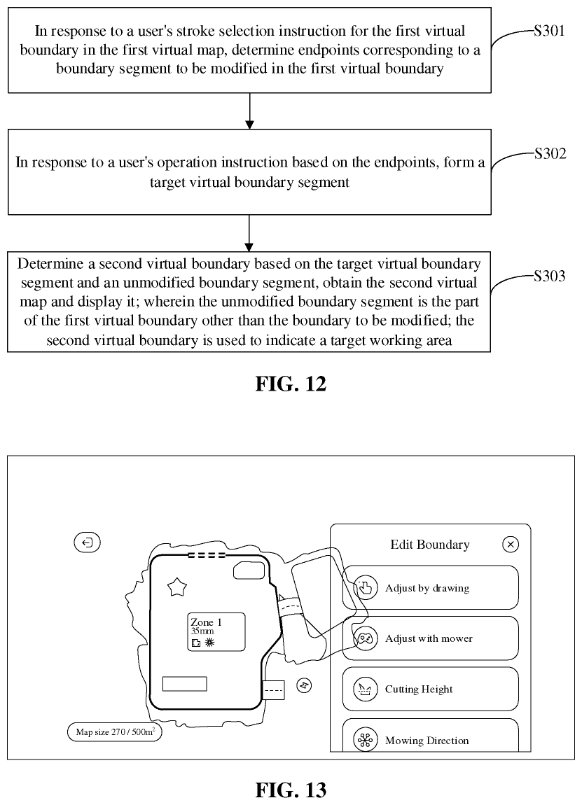

Please refer to FIG. 12, which is a fourth schematic flow diagram of a method for map modification provided by an embodiment of the present disclosure. S102 in FIG. 1 can also be implemented through S301 to S303, which will be described in conjunction with the steps.
S301, in response to a stroke selection instruction from the user for the first virtual boundary in the first virtual map, determining endpoints corresponding to a boundary segment to be modified in the first virtual boundary.

In the embodiments of the present disclosure, the client can respond to a user instruction (voice instruction or touch instruction) to jump from the page displaying the first virtual map to the map editing page. On this page, the user can perform a stroke selection on the boundary segment to be modified in the first virtual boundary. The client, in response to the user's stroke selection instruction on the first virtual boundary, determines the boundary segment to be modified in the first virtual boundary, and the first endpoint and the second endpoint at the two ends of the boundary segment to be modified.

In the embodiments of the present disclosure, after determining the boundary segment to be modified in response to the stroke selection instruction, the client can highlight the boundary segment to be modified in the first virtual map. The client can respond to the user's deletion operation on the boundary segment to be modified to delete the boundary segment to be modified in the first virtual map.

Exemplarily, referring to FIG. 13, the user can touch the human-computer interaction adjustment button (Adjust by drawing) on the client, and the client can respond to the user's touch instruction to jump to the map editing page.

In the embodiments of the present disclosure, the client can, in response to the stroke selection instruction, enlarge and display a first enlarged view of a first operation area at a first preset position; wherein the first operation area is a preset range area corresponding to an operation point of the stroke selection instruction on the first virtual boundary; the first enlarged view includes a segment of the first virtual boundary stroked by the stroke selection instruction. Thus, the user can more clearly view the area selected by the stroke selection instruction, thereby improving the accuracy of the determined boundary segment to be modified and the accuracy of the second virtual map.

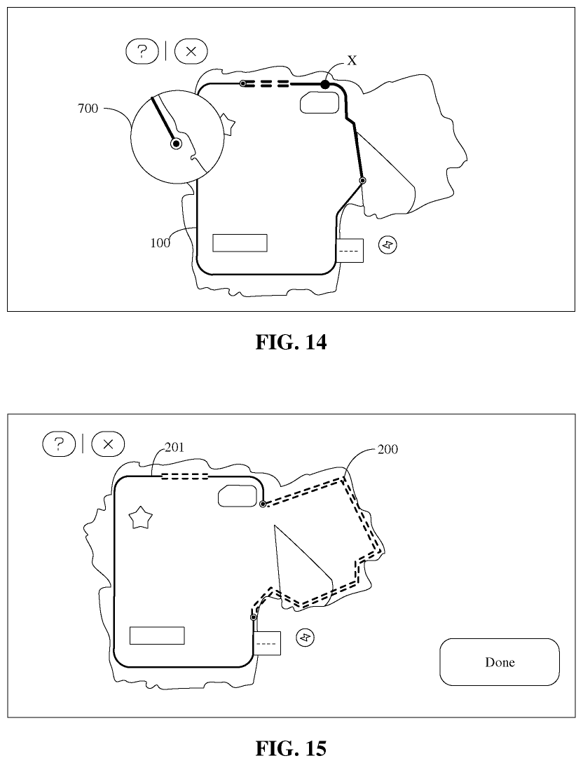

Exemplarily, referring to FIG. 14, the user's stroke selection instruction can act on point X on the first virtual boundary 100 at a certain time point, and the first enlarged view 700 enlarges and displays the preset range area corresponding to point X. There is a magnifying glass in the upper left corner displaying the first enlarged view 700 near the finger, thereby facilitating the user to more accurately select the boundary segment to be adjusted through both global and local perspectives.

In the embodiments of the present disclosure, after the user determines to enter this interface, the user needs to use a finger to stroke and select the portion of the mowing map boundary to be adjusted. After a one-time stroke, the user can also continue to fine-tune from the two endpoints of the stroked boundary, or re-stroke and select a new segment of boundary to be adjusted (the last stroke is taken as the boundary to be adjusted).
S302, in response to an operation instruction from the user based on the endpoints, forming a target virtual boundary segment.

In the embodiments of the present disclosure, the client can respond to a dragging operation instruction from the user between the first endpoint and the second endpoint, and connect the dragging trajectory indicated by the dragging operation instruction with the first endpoint and the second endpoint to form a target virtual boundary segment.

In the embodiments of the present disclosure, the client can also respond to a movement operation instruction from the user for the first endpoint and/or the second endpoint, and form a target virtual boundary segment according to the movement trajectory indicated by the movement operation instruction.

In the embodiments of the present disclosure, in response to the operation instruction for the endpoints, a second enlarged view of a second operation area is enlarged and displayed at a second preset position; wherein the second operation area is a preset range area corresponding to a dragging trajectory point of the operation instruction; the second enlarged view includes the corresponding dragging trajectory. Thus, the user can more clearly view the area of the operation instruction, thereby improving the accuracy of determining the target virtual boundary segment and the accuracy of the second virtual map.
S303, determining a second virtual boundary based on the target virtual boundary segment and an unmodified boundary segment, obtaining the second virtual map for display; wherein the unmodified boundary segment is the part of the first virtual boundary other than the boundary to be modified; the second virtual boundary is used to indicate the target working area.

In the embodiments of the present disclosure, the client can connect the target virtual boundary segment and the unmodified boundary segment to determine the second virtual boundary, and determine the area enclosed by the second virtual boundary as the target working area. Then, the second virtual map for display is formed by the determined second virtual boundary. The unmodified boundary segment is the part of the first virtual boundary other than the boundary to be modified; the second virtual boundary is used to indicate the target working area.

Exemplarily, referring to FIG. 15, it is the formed second virtual map, in which the target virtual boundary segment 200 and the unmodified boundary segment 201 are connected to form the second virtual boundary. The client temporarily saves the second virtual map, and the user can continue the next map boundary stroke selection and setting adjustment based on this saved version.

In the embodiments of the present disclosure, in response to a stroke selection instruction from the user for the first virtual boundary in the first virtual map, endpoints corresponding to a boundary segment to be modified in the first virtual boundary are determined; in response to an operation instruction from the user based on the endpoints, a target virtual boundary segment is formed; a second virtual boundary is determined based on the target virtual boundary segment and an unmodified boundary segment, and the second virtual map is obtained for display. Thus, since the first virtual map displays the overlapping sketch primitives and first virtual boundary primitives, the user can accurately operate based on the endpoints according to the positional relationship between the sketch primitives and the first virtual boundary primitives in the first virtual map, forming a target virtual boundary segment with relatively high accuracy, thereby obtaining a second virtual map with relatively high boundary accuracy.

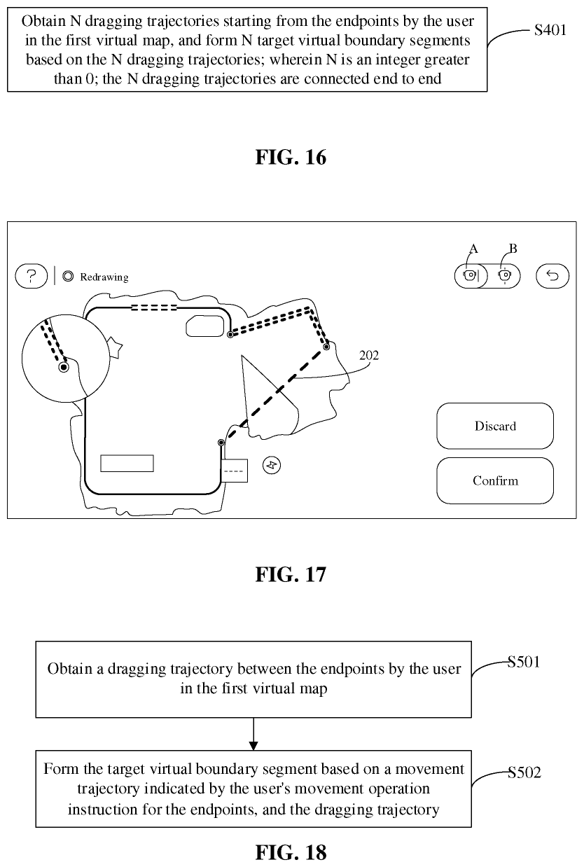

Please refer to FIG. 16, which is a fifth schematic flow diagram of a method for map modification provided by an embodiment of the present disclosure. Description will be made in conjunction with the steps.
S401, obtaining N dragging trajectories from the user starting from the endpoints in the first virtual map, and forming N target virtual boundary segments based on the N dragging trajectories; wherein N is an integer greater than 0; the N dragging trajectories are connected end to end.

In the embodiments of the present disclosure, the user can start a dragging operation from any of the first endpoint and the second endpoint in the first virtual map. Each dragging operation, the client obtains a corresponding dragging trajectory, until the user performs N dragging operations, the client obtains N dragging trajectories. The client forms N target virtual boundary segments by connecting the N dragging trajectories end to end in the first virtual map, and the N target virtual boundary segments form the final target virtual boundary segment. N is an integer greater than 0; the N dragging trajectories are connected end to end.

In the embodiments of the present disclosure, the client can also connect the first endpoint, the N target virtual boundary segments, and the second endpoint in sequence to form the target virtual boundary segment.

In the embodiments of the present disclosure, the client, in response to a boundary attribute selection instruction from the user for the M-th dragging trajectory, determines a boundary attribute of the M-th target virtual boundary segment corresponding to the M-th dragging trajectory. Thus, when adjusting the target virtual boundary segment, the user can set a corresponding boundary attribute for each small segment, which improves the diversity and accuracy of boundary attributes, enabling the intelligent mobile device to mow according to the boundary attribute with higher accuracy, improving the boundary mowing coverage.

Herein, before drawing each dragging trajectory in the first virtual map, the user can set in advance the corresponding boundary attribute for one target virtual boundary segment corresponding to that dragging trajectory.

Exemplarily, referring to FIG. 17, before drawing each dragging trajectory, the user can click boundary attribute button A or boundary attribute button B to select the boundary attribute of the corresponding target virtual boundary segment. Exemplarily, the user clicks boundary attribute button A to determine that the boundary attribute of the target virtual boundary segment 202 corresponding to the next dragging trajectory is: the intelligent mobile device is adjacent to the boundary.

In the embodiments of the present disclosure, N dragging trajectories from the user starting from the endpoints in the first virtual map are obtained, and N target virtual boundary segments are formed based on the N dragging trajectories; wherein N is an integer greater than 0; the N dragging trajectories are connected end to end. Thus, the method of forming N dragging trajectories between two endpoints and then forming a target virtual boundary segment based on the N dragging trajectories is simple and intuitive, and can quickly form the target virtual boundary segment desired by the user.

Please refer to FIG. 18, which is a sixth schematic flow diagram of a method for map modification provided by an embodiment of the present disclosure. S302 in FIG. 12 can also be implemented through S501 to S502, which will be described in conjunction with the steps:
S501, obtaining a dragging trajectory between the endpoints from the user in the first virtual map.

In the embodiments of the present disclosure, the user can perform a dragging motion between the first endpoint and the second endpoint in the first virtual map, and the client obtains the dragging trajectory of the user between the first endpoint and the second endpoint.
S502, forming the target virtual boundary segment based on a movement trajectory indicated by a movement operation instruction from the user for the endpoints, and the dragging trajectory.

In the embodiments of the present disclosure, the user can click and move any endpoint in the first virtual map, and the client obtains the movement trajectory indicated by the movement operation instruction for any endpoint. The client connects the movement trajectory with the dragging trajectory to form the target virtual boundary segment.

In some other embodiments, it is detected that the stroke selection instruction is terminated during a stroking process of the user, and a straight line is formed between the two endpoints according to the stroke selection instruction; in response to a confirmation instruction from the user, it is determined that the straight line and the unmodified boundary segment form the target virtual boundary segment.

In the embodiments of the present disclosure, a dragging trajectory between the endpoints from the user in the first virtual map is obtained. The target virtual boundary segment is formed based on a movement trajectory indicated by a movement operation instruction from the user for the endpoints, and the dragging trajectory. Thus, the method of forming a dragging trajectory between two endpoints and then combining the dragging trajectory with the movement trajectory of the endpoints to form the target virtual boundary segment is simple and intuitive, and can quickly form the target virtual boundary segment desired by the user.

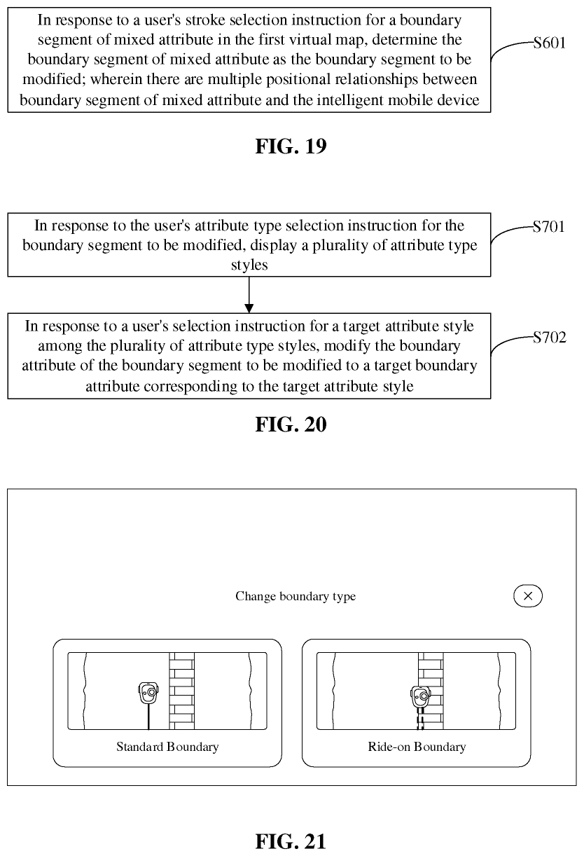

Please refer to FIG. 19, which is a seventh schematic flow diagram of a method for map modification provided by an embodiment of the present disclosure. Description will be made in conjunction with the steps.
S601, in response to the stroke selection instruction from the user for a boundary segment of mixed attributes in the first virtual map, determining the boundary segment of mixed attributes as the boundary segment to be modified; wherein there are multiple positional relationships the boundary segment of mixed attributes and the intelligent mobile device.

In the embodiments of the present disclosure, the attributes of the first virtual boundary in the first virtual map can be different. The first virtual boundary may include a boundary segment of mixed attributes. The primitive of the boundary segment of mixed attributes is different from the primitives of other boundary segments. The user can perform a stroke selection on the boundary segment of mixed attributes in the first virtual map, and the client, in response to the stroke selection instruction, determines the boundary segment of mixed attributes as the boundary segment to be modified.

There are multiple positional relationships the boundary segment of mixed attributes and the intelligent mobile device. Exemplarily, the multiple positional relationships indicated by the mixed attributes may include: the intelligent mobile device is inside the boundary segment, the intelligent mobile device is outside the boundary segment, and the intelligent mobile device coincides with the boundary segment.

In the embodiments of the present disclosure, in response to the user's stroke selection instruction for the boundary segment of mixed attributes in the first virtual map, the boundary segment of mixed attributes is determined as the boundary segment to be modified. Since the display primitive of the mixed-attribute boundary segment is different from that of other boundary segments, the user can quickly stroke and select the boundary segment to be modified in the first virtual boundary, and then modify the boundary segment to be modified, improving the generation efficiency of the second virtual map.

Please refer to FIG. 20, which is an eighth schematic flow diagram of a method for map modification provided by an embodiment of the present disclosure. The steps will be described in conjunction with the following:
S701, in response to an attribute type selection instruction from the user for the boundary segment to be modified, displaying multiple attribute type styles.

In the embodiments of the present disclosure, the client, in response to the attribute type selection instruction from the user for the boundary segment to be modified, displays multiple attribute type styles.

Among them, an attribute type style with the intelligent mobile device inside the boundary segment, an attribute type style with the intelligent mobile device outside the boundary segment, and an attribute type style with the intelligent mobile device coinciding with the boundary segment can be displayed.

The attribute type styles may include: a straddling travel attribute style, a boundary-inside edge travel attribute style, and a boundary-outside edge travel attribute style; the straddling travel attribute represents that the physical boundary is lower than the chassis of the lawn mower, and there is no dangerous object outside the physical boundary; the boundary-inside edge travel attribute represents that the physical boundary is higher than the chassis of the lawn mower; the boundary-outside edge travel attribute represents that the physical boundary is lower than the chassis of the lawn mower, and the area outside the physical boundary is a grassy area that can be traveled on. Exemplarily, referring to FIG. 21, the client can display a boundary-inside edge travel attribute style (Standard Boundary) and a straddling travel attribute style (Ride-on Boundary).
S702, in response to a selection instruction from the user for a target attribute style among the multiple attribute type styles, modifying the boundary attribute of the boundary segment to be modified to a target boundary attribute corresponding to the target attribute style.

In the embodiments of the present disclosure, the client, in response to the selection instruction from the user for the target attribute style among the multiple attribute type styles, modifies the boundary attribute of the boundary segment to be modified to the target boundary attribute corresponding to the target attribute style. That is, the primitive of the boundary segment to be modified is modified using the primitive corresponding to the target boundary attribute.

Exemplarily, the solid line corresponding to the boundary segment to be modified can be modified to a dashed line primitive corresponding to the target boundary attribute.

In the embodiments of the present disclosure, after the stroke selection of the boundary is completed, the user can choose to modify the attribute of this segment of boundary, or choose to adjust the shape of this segment of boundary. If the attribute of the boundary is modified, regardless of whether this segment is a single attribute or mixed attributes, it can be selected, and then set to a certain attribute. If the shape of the boundary is adjusted, the user can start from the two endpoints of the previously selected segment of boundary and freely draw the desired boundary shape by dragging. During the drawing process, a magnifying glass also exists in the upper left corner to display the situation near the finger, facilitating the user to accurately draw based on both global and local perspectives. In addition, during the drawing process, the user can choose the type of the next drawn boundary segment.

In the embodiments of the present disclosure, in response to an attribute type selection instruction from the user for the boundary segment to be modified, multiple attribute type styles are displayed. In response to a selection instruction from the user for a target attribute style among the multiple attribute type styles, the boundary attribute of the boundary segment to be modified is modified to the target boundary attribute corresponding to the target attribute style. Thus, the solution of selecting a target attribute style among multiple attribute type styles can quickly modify the attribute of the boundary segment to be modified, thereby quickly generating the second virtual map.

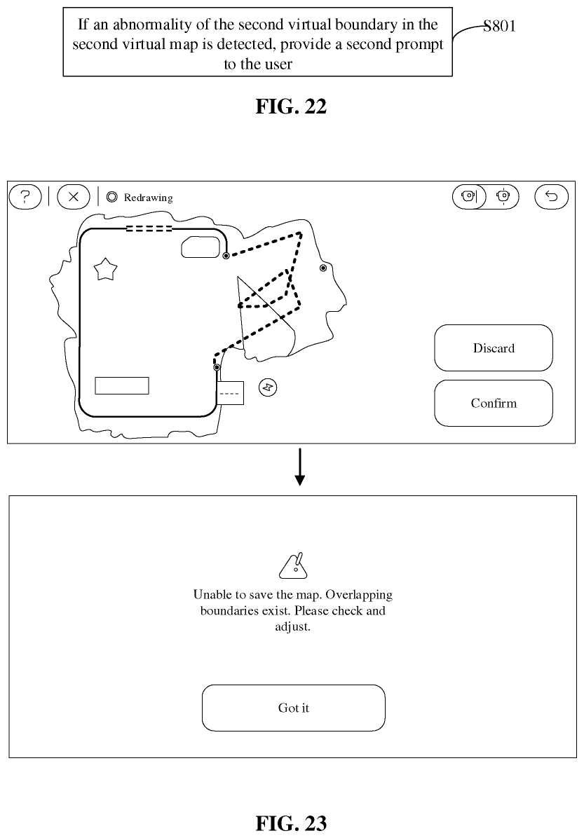

Please refer to FIG. 22, which is a ninth schematic flow diagram of a method for map modification provided by an embodiment of the present disclosure. Description will be made in conjunction with the steps.
S801, if it is detected that the second virtual boundary in the second virtual map is abnormal, performing a second prompt to the user.

In the embodiments of the present disclosure, if the client detects that the second virtual boundary in the second virtual map has an intersection abnormality or an out-of-range abnormality, it can perform a page jump to form a second prompt to the user. The second prompt is used to prompt the user that the current second virtual boundary is abnormal and a new second virtual boundary needs to be formed again.

Herein, if it is detected that the N target virtual boundary segments in the second virtual boundary self-intersect, the second prompt is performed to the user.

Exemplarily, referring to FIG. 23, the client detects that self-intersection occurs when drawing the second virtual boundary. After completion, the system prompts: “Unable to save map, overlapping boundaries exist. Please check and adjust.”

Herein, if it is detected that the second virtual boundary intersects a preset functional area, the second prompt is performed to the user. The preset functional area may include: a forbidden area and an invalid area.

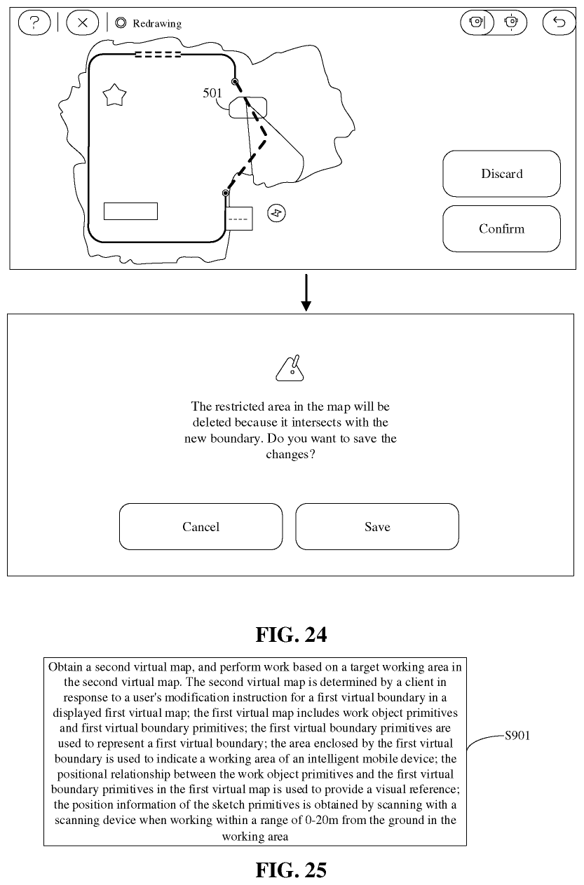

Exemplarily, referring to FIG. 24, the client detects that the second virtual boundary intersects the forbidden area 501 when drawing. After completion, the system prompts the user: “The restricted area in the map will be deleted due to intersection with the new boundary. Do you want to save the changes?”

In the embodiments of the present disclosure, after drawing is completed, the system determines whether there are logical problems with the currently drawn boundary, such as whether the boundary self-intersects, whether the boundary intersects with a forbidden area, etc. After the check is completed, if there is a problem, the result is returned to the user and the user is prompted to modify it. This can prevent abnormal situations when adjusting the virtual boundary, improve the accuracy of the determined virtual boundary, and obtain a second virtual map with higher accuracy. If there is no problem, the drawn map is temporarily saved, and the user can continue the next map boundary stroke selection and setting adjustment based on this saved version. If the user does not want to continue modifying and adjusting, the user can save the final result and end.

Please refer to FIG. 25, which is a first schematic flow diagram of a method for device control provided by an embodiment of the present disclosure. Description will be made in conjunction with the steps.
S901, obtaining a second virtual map, and working based on the second virtual map. Herein the second virtual map is determined by a client in response to a modification instruction from a user for a first virtual boundary in a displayed first virtual map; the first virtual map includes sketch primitives and first virtual boundary primitives; the first virtual boundary primitives are used to represent a first virtual boundary; the area enclosed by the first virtual boundary is used to indicate a working area of an intelligent mobile device; the positional relationship between the sketch primitives and the first virtual boundary primitives in the first virtual map is used to provide a visual reference; the position information of the sketch primitives is obtained by scanning when a scanning device works within a range of 0-20 m above the ground in the working area.

In the embodiments of the present disclosure, the intelligent mobile device obtains the second virtual map from the client. It moves and works according to the virtual boundary in the second virtual map, and during the working process, it refers to the positional relationship between the boundary attribute settings in the second virtual map and the actual physical boundary.

In the embodiments of the present disclosure, the intelligent mobile device obtains a second virtual map, and works based on the second virtual map.

Herein, the second virtual map is determined by a client in response to a modification instruction from a user for a first virtual boundary in a displayed first virtual map, and the first virtual map is a virtual map determined by the client after displaying a first map style and a second map style, corresponding to the first map style; the color or identification pattern representing grass and non-grass in the first map style is different from that in the second map style, and the first map style and the second map style at least include boundary primitives; the first virtual map includes first virtual boundary primitives representing a first virtual boundary, the area enclosed by the first virtual boundary being used to indicate a working area of the intelligent mobile device.

In the embodiments of the present disclosure, the intelligent mobile device obtains a second virtual map, and works based on the second virtual map.

Herein, the second virtual map is formed by a client, in response to a selection instruction from a user for a displayed first virtual map, selecting a boundary segment to be modified, and in response to a boundary attribute type modification instruction from the user for the boundary segment to be modified, modifying the boundary attribute of the boundary segment to be modified; the first virtual map includes a first virtual boundary, the area enclosed by the first virtual boundary being used to indicate a working area of the intelligent mobile device; the boundary attribute is used to indicate the positional relationship between the intelligent mobile device and the first virtual boundary, or the positional relationship between the intelligent mobile device and a physical boundary corresponding to the first virtual boundary.

In the embodiments of the present disclosure, the intelligent mobile device obtains a first virtual map, and works based on a first virtual boundary in the first virtual map; wherein the first virtual map is obtained by a client displaying a first virtual map in an interactive page; wherein the first virtual map includes a first virtual boundary, a first boundary map including primitives representing the first virtual boundary, the area enclosed by the first virtual boundary being used to indicate a working area of the intelligent mobile device; detecting a first touch event acting on the first virtual boundary, determining a coordinate point in the first boundary map corresponding to the touch point according to the touch point of the first touch event; enlarging and displaying a preset area containing the coordinate point in the first boundary map at a preset position of the interactive page, to obtain a partial enlarged view.

In the embodiments of the present disclosure, the intelligent mobile device obtains a second virtual map, and works based on the second virtual map.

Herein, the second virtual map is determined by a client, in response to a selection instruction from a user for a displayed first virtual map, selecting endpoints of a boundary segment to be modified, forming a target virtual boundary segment and an unmodified boundary segment based on the endpoints and a dragging operation instruction from the user between the endpoints; the unmodified boundary segment is the part of the first virtual boundary other than the boundary to be modified; the first virtual map includes a first virtual boundary, the area enclosed by the first virtual boundary being used to indicate a working area of the intelligent mobile device.

In the embodiments of the present disclosure, by obtaining a second virtual map and working based on the second virtual map, wherein the second virtual map is determined by a client in response to a modification instruction from a user for a first virtual boundary in a displayed first virtual map; the first virtual map includes sketch primitives and first virtual boundary primitives representing a first virtual boundary, the area enclosed by the first virtual boundary is used to indicate a working area of the intelligent mobile device; the positional relationship between the sketch primitives and the first virtual boundary primitives in the first virtual map is used to provide a visual reference; the position information of the sketch primitives is obtained by scanning when a scanning device works within a range of 0-20 m above the ground in the working area. Thus, because the positional relationship between the sketch primitives and the first virtual boundary primitives in the first virtual map is used to provide a visual reference for the user, the user can accurately modify and adjust the first virtual boundary according to the positional relationship between the sketch primitives and the first virtual boundary primitives in the first virtual map, thereby obtaining a second virtual map with relatively high boundary accuracy. After the intelligent mobile device works using the second virtual map with relatively high boundary accuracy as a reference, it can accurately process the work objects, thereby improving the mowing coverage of the intelligent mobile device at the boundary.

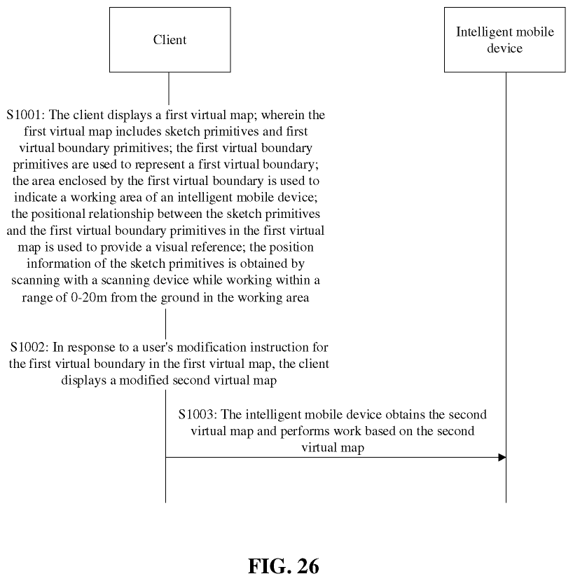

Please refer to FIG. 26, which is an interaction schematic diagram of a method for map modification provided by an embodiment of the present disclosure. Description will be made in conjunction with the steps.
S1001, displaying a first virtual map; wherein the first virtual map includes sketch primitives and first virtual boundary primitives; the first virtual boundary primitives are used to represent a first virtual boundary; the area enclosed by the first virtual boundary is used to indicate a working area of an intelligent mobile device; the positional relationship between the sketch primitives and the first virtual boundary primitives in the first virtual map is used to provide a visual reference; the position information of the sketch primitives is obtained by scanning when a scanning device works within a range of 0-20 m above the ground in the working area.

In the embodiments of the present disclosure, the implementation steps of S1001 can refer to the implementation steps of S101, and will not be described in detail here.
S1002, in response to a modification instruction from the user for the first virtual boundary in the first virtual map, displaying a modified second virtual map.

In the embodiments of the present disclosure, the implementation steps of S1002 can refer to the implementation steps of S102, and will not be described in detail here.
S1003, the intelligent mobile device obtains the second virtual map, and works based on the second virtual map.

In the embodiments of the present disclosure, the implementation steps of S1003 can refer to the implementation steps of S901, and will not be described in detail here.

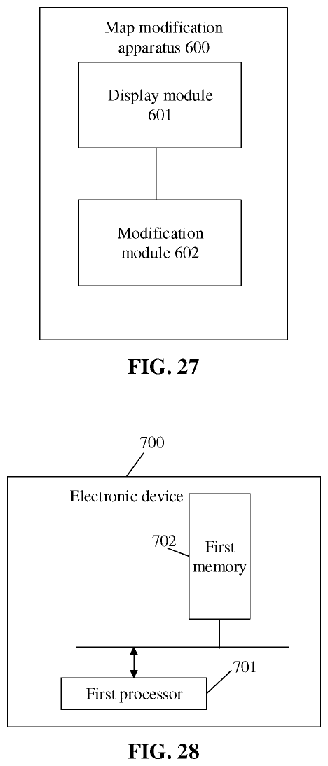

Please refer to FIG. 27, which is a structural schematic diagram of an apparatus for map modification provided by an embodiment of the present disclosure:

The embodiments of the present disclosure provide an apparatus for map modification 600, configured to be applied to a client, including: a display module 601 and a modification module 602.

The display module 601 is configured to display a first virtual map; wherein the first virtual map includes sketch primitives and first virtual boundary primitives representing a first virtual boundary, the area enclosed by the first virtual boundary is configured to indicate a working area of an intelligent mobile device; the positional relationship between the sketch primitives and the first virtual boundary primitives in the first virtual map is configured to provide a visual reference; the position information of the sketch primitives is obtained by scanning when a scanning device works within a range of 0-20 m above the ground in the working area.

The modification module 602 is configured to, in response to a modification instruction from a user for the first virtual boundary in the first virtual map, display a modified second virtual map.

In the embodiments of the present disclosure, the position information of the sketch primitives is obtained by scanning by an intelligent lawn mower or a handheld mobile device or an unmanned aerial vehicle.

In the embodiments of the present disclosure, the scanning device can obtain the position information of the sketch primitives by scanning using one or more of radar, vision and infrared; the positioning sensor of the scanning device includes data fusion of one or more of RTK, IMU and wheel speedometer.

In the embodiments of the present disclosure, the intelligent mobile device includes: a virtual boundary establishing stage and a mowing stage according to the virtual boundary;
in the virtual boundary establishing stage, the first virtual map is formed by the intelligent mobile device recording multiple position points using a positioning sensor and then performing data processing during the process of moving along the boundary of the working area.

In the mowing stage according to the virtual boundary, the working path of the intelligent mobile device along the first virtual boundary includes: a bow-shaped path, a linear path, a rectangular spiral path, a grid-shaped path and a spiral path.

In the embodiments of the present disclosure, the position information of the sketch primitives is obtained by the intelligent mobile device during the mowing stage according to the virtual boundary, or obtained by scanning during the virtual boundary establishing stage.

In the embodiments of the present disclosure, the first virtual map further includes: obstacle primitives; the color of the sketch primitives is different from the color of the obstacle primitives.

In the embodiments of the present disclosure, the modification module 602 in the apparatus for map modification 600 is configured to, in response to an operation instruction from a user, align and overlap the coordinate positions of a first boundary map and a background map displayed on a home page to obtain the first virtual map.

Herein, the first boundary map includes the first virtual boundary primitives representing the first virtual boundary; the background map includes sketch primitives.

In the embodiments of the present disclosure, the modification module 602 in the apparatus for map modification 600 is configured to, in response to an overlap display operation instruction from a user, display multiple map styles on the home page.

In response to a selection instruction from the user for a target style among the multiple map styles, align and overlap the coordinate positions of the background map corresponding to the target style and the first boundary map to obtain the first virtual map.

In the embodiments of the present disclosure, the display module 601 in the apparatus for map modification 600 is configured to, if the first virtual boundary in the first virtual map is not completely covered by the sketch primitives, perform a first prompt to the user after jumping to a predetermined interface; wherein the first prompt is configured to remind the user to refer to the sketch primitives when modifying the first virtual boundary.

In the embodiments of the present disclosure, the display module 601 in the apparatus for map modification 600 is configured to, if the area of the first virtual boundary in the first virtual map covering the sketch primitives is less than a predetermined ratio, perform a first prompt to the user after jumping to the predetermined interface.

In the embodiments of the present disclosure, the modification module 602 in the apparatus for map modification 600 is configured to, in response to a stroke selection instruction from the user for the first virtual boundary in the first virtual map, determine endpoints corresponding to a boundary segment to be modified in the first virtual boundary; in response to an operation instruction from the user based on the endpoints, form a target virtual boundary segment; and determine a second virtual boundary based on the target virtual boundary segment and an unmodified boundary segment, and obtain the second virtual map for display. Herein, the unmodified boundary segment is the part of the first virtual boundary other than the boundary to be modified; the second virtual boundary is configured to indicate the target working area.

In the embodiments of the present disclosure, the modification module 602 in the apparatus for map modification 600 is configured to obtain N dragging trajectories from the user starting from the endpoints in the first virtual map, and form N target virtual boundary segments based on the N dragging trajectories; wherein N is an integer greater than 0; the N dragging trajectories are connected end to end.

In the embodiments of the present disclosure, the modification module 602 in the apparatus for map modification 600 is configured to, in response to a boundary attribute selection instruction from the user for the M-th dragging trajectory, determine a boundary attribute of the M-th target virtual boundary segment corresponding to the M-th dragging trajectory.

In the embodiments of the present disclosure, the modification module 602 in the apparatus for map modification 600 is configured to obtain a dragging trajectory between the endpoints from the user in the first virtual map; and form the target virtual boundary segment based on a movement trajectory indicated by a movement operation instruction from the user for the endpoints, and the dragging trajectory.

In the embodiments of the present disclosure, the display module 601 in the apparatus for map modification 600 is configured to, in response to the stroke selection instruction, enlarge and display a first enlarged view of a first operation area at a first preset position; wherein the first operation area is a preset range area corresponding to an operation point of the stroke selection instruction on the first virtual boundary; the first enlarged view includes a segment of the first virtual boundary stroked by the stroke selection instruction.

In the embodiments of the present disclosure, the display module 601 in the apparatus for map modification 600 is configured to, in response to the operation instruction for the endpoints, enlarge and display a second enlarged view of a second operation area at a second preset position; wherein the second operation area is a preset range area corresponding to a dragging trajectory point of the operation instruction; the second enlarged view includes the corresponding dragging trajectory.

In the embodiments of the present disclosure, the modification module 602 in the apparatus for map modification 600 is configured to, in response to the stroke selection instruction from the user for a boundary segment of mixed attributes in the first virtual map, determine the boundary segment of mixed attributes as the boundary segment to be modified; wherein there are multiple positional relationships the boundary segment of mixed attributes and the intelligent mobile device.

In the embodiments of the present disclosure, the modification module 602 in the apparatus for map modification 600 is configured to, in response to an attribute type selection instruction from the user for the boundary segment to be modified, display multiple attribute type styles; and in response to a selection instruction from the user for a target attribute style among the multiple attribute type styles, modify the boundary attribute of the boundary segment to be modified to a target boundary attribute corresponding to the target attribute style.

In the embodiments of the present disclosure, the display module 601 in the apparatus for map modification 600 is configured to, if it is detected that the second virtual boundary in the second virtual map is abnormal, perform a second prompt to the user.

In the embodiments of the present disclosure, the display module 601 in the apparatus for map modification 600 is configured to, if it is detected that the N target virtual boundary segments in the second virtual boundary self-intersect, perform the second prompt to the user; if it is detected that the second virtual boundary intersects a preset functional area, perform the second prompt to the user.

It should be noted that, in the embodiments of the present disclosure, if the above method for map modification is implemented in the form of a software function module and sold or used as an independent product, it may also be stored in a computer-readable storage medium. Based on such understanding, the technical solution of the embodiments of the present disclosure essentially, or the part contributing to the related art, can be embodied in the form of a software product. The computer software product is stored in a storage medium and includes several instructions for causing an apparatus for map modification (which may be a personal computer, etc.) to execute all or part of the methods described in the various embodiments of the present disclosure. The aforementioned storage medium includes: U disk, mobile hard disk, Read Only Memory (ROM), magnetic disk, or optical disk, and other various media that can store program code. Thus, the embodiments of the present disclosure are not limited to any specific combination of hardware and software.

Correspondingly, the embodiments of the present disclosure provide a computer-readable storage medium having a computer program stored thereon, which, when executed by a first processor, implements the steps in the method on the client side.

It should be noted here that the description of the storage medium and apparatus embodiments above is similar to the description of the method embodiments and has similar beneficial effects as the method embodiments. For technical details not disclosed in the storage medium and apparatus embodiments of the present disclosure, please refer to the description of the method embodiments of the present disclosure for understanding.

It should be noted that FIG. 28 is a first schematic diagram of a hardware entity of an electronic device provided by an embodiment of the present disclosure. As shown in FIG. 28, an embodiment of the present disclosure provides an electronic device 700, including a first memory 702 and a first processor 701. The first memory 702 stores a computer program executable on the first processor 701. The first processor 701 executes the program to implement the steps in the above method.

The first processor 701 generally controls the overall operation of the electronic device 700.

The first memory 702 is configured to store instructions and applications executable by the first processor 701, and can also cache data (e.g., image data, audio data, voice communication data, and video communication data) to be processed or already processed by the first processor 701 and various modules in the electronic device 700, and can be implemented by flash memory or Random Access Memory (RAM).

Correspondingly, an embodiment of the present disclosure also provides a computer program product, including a computer program, which can be executed by the processor 701 of the electronic device 700 to complete the steps in the method on the apparatus for map modification 600 side.

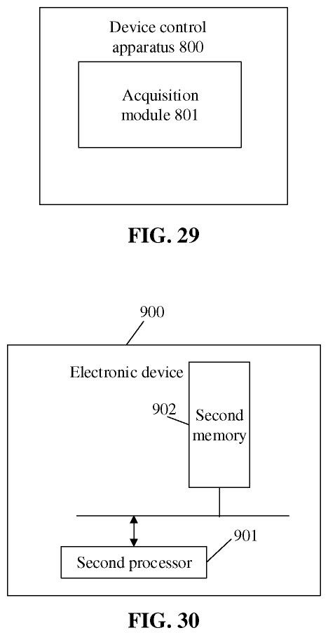

Reference will be made to FIG. 29, which is a structural schematic diagram of a device control apparatus provided by an embodiment of the present disclosure.

The embodiments of the present disclosure also provide a device control apparatus 800, applied to an intelligent mobile device, including: an acquisition module 801.

The acquisition module 801 is configured to obtain a second virtual map, and work based on the second virtual map.

Herein, the second virtual map is determined by a client in response to a modification instruction from a user for a first virtual boundary in a displayed first virtual map; the first virtual map includes sketch primitives and first virtual boundary primitives representing a first virtual boundary, the area enclosed by the first virtual boundary is used to indicate a working area of the intelligent mobile device; the positional relationship between the sketch primitives and the first virtual boundary primitives in the first virtual map is used to provide a visual reference; the position information of the sketch primitives is obtained by scanning when a scanning device works within a range of 0-20 m above the ground in the working area.

Correspondingly, the embodiments of the present disclosure provide a computer-readable storage medium having a computer program stored thereon, which, when executed by a second processor, implements the steps in the method on the client side.

It should be noted here that the description of the storage medium and apparatus embodiments above is similar to the description of the method embodiments and has similar beneficial effects as the method embodiments. For technical details not disclosed in the storage medium and apparatus embodiments of the present disclosure, please refer to the description of the method embodiments of the present disclosure for understanding.

It should be noted that FIG. 30 is a second schematic diagram of a hardware entity of an electronic device provided by an embodiment of the present disclosure. As shown in FIG. 30, an embodiment of the present disclosure provides an electronic device 900, including a second memory 902 and a second processor 901. The second memory 902 stores a computer program executable on the second processor 901. The second processor 901 executes the program to implement the steps in the above method.

The second processor 901 generally controls the overall operation of the electronic device 900.

The second memory 902 is configured to store instructions and applications executable by the second processor 901, and can also cache data (e.g., image data, audio data, voice communication data, and video communication data) to be processed or already processed by the second processor 901 and various modules in the electronic device 900, and can be implemented by flash memory or Random Access Memory (RAM).

Correspondingly, an embodiment of the present disclosure also provides a computer program product, including a computer program, which can be executed by the second processor 901 of the electronic device 900 to complete the steps in the method on the device control apparatus 800 side.

The embodiments of the present disclosure further include at least the following solutions:

An embodiment of the present disclosure provides a method for map modification, including:
displaying a first virtual map; wherein the first virtual map includes sketch primitives and first virtual boundary primitives; the first virtual boundary primitives are used to represent a first virtual boundary; an area enclosed by the first virtual boundary is used to indicate a working area of an intelligent mobile device; a positional relationship between the sketch primitives and the first virtual boundary primitives in the first virtual map is used to provide a visual reference; position information of the sketch primitives is obtained by scanning when a scanning device works within a range of 0-20 m above ground in the working area;
in response to a modification instruction from a user for the first virtual boundary in the first virtual map, displaying a modified second virtual map.

In the above solution, the position information of the sketch primitives is obtained by scanning by an intelligent lawn mower or a handheld mobile device or an unmanned aerial vehicle.

In the above solution, the scanning device can obtain the position information of the sketch primitives by scanning using one or more of radar, vision and infrared; a positioning sensor of the scanning device includes one or more of RTK, IMU and a wheel speedometer.

In the above solution, the intelligent mobile device includes: a virtual boundary establishing stage and a mowing stage according to the virtual boundary;
in the virtual boundary establishing stage, the first virtual map is formed by the intelligent mobile device recording multiple position points using a positioning sensor and then performing data processing during a process of moving along a boundary of the working area;
in the mowing stage according to the virtual boundary, a working path of the intelligent mobile device along the first virtual boundary includes: a bow-shaped path, a linear path, a rectangular spiral path, a grid-shaped path and a spiral path.

In the above solution, the position information of the sketch primitives is obtained by the intelligent mobile device during the mowing stage according to the virtual boundary, or obtained by scanning during the virtual boundary establishing stage.

In the above solution, the first virtual map further includes: obstacle primitives; a color of the sketch primitives is different from a color of the obstacle primitives.

In the above solution, the responding to a modification instruction from a user for the first virtual boundary in the first virtual map, and displaying a modified second virtual map, includes:
in response to a stroke selection instruction from the user for the first virtual boundary in the first virtual map, determining endpoints corresponding to a boundary segment to be modified in the first virtual boundary;
in response to an operation instruction from the user based on the endpoints, forming a target virtual boundary segment;
determining a second virtual boundary based on the target virtual boundary segment and an unmodified boundary segment, obtaining the second virtual map for display; wherein the unmodified boundary segment is a part of the first virtual boundary other than the boundary to be modified.

In the above solution, the target virtual boundary segment includes: N target virtual boundary segments; the responding to an operation instruction from the user based on the endpoints, forming a target virtual boundary segment, includes:
obtaining N dragging trajectories from the user starting from the endpoints in the first virtual map, and forming N target virtual boundary segments based on the N dragging trajectories; wherein N is an integer greater than 0; the N dragging trajectories are connected end to end.

In the above solution, before obtaining an M-th dragging trajectory of the user in the first virtual map; wherein M is any integer from 1 to N; the method further includes:
in response to a boundary attribute selection instruction from the user for the M-th dragging trajectory, determining a boundary attribute of an M-th target virtual boundary segment corresponding to the M-th dragging trajectory.

In the above solution, the responding to an operation instruction from the user based on the endpoints, forming a target virtual boundary segment, includes:
obtaining a dragging trajectory between the endpoints from the user in the first virtual map;
forming the target virtual boundary segment based on a movement trajectory indicated by a movement operation instruction from the user for the endpoints, and the dragging trajectory.

In the above solution, the method further includes:
in response to the stroke selection instruction, enlarging and displaying a first enlarged view of a first operation area at a first preset position; wherein the first operation area is a preset range area corresponding to an operation point of the stroke selection instruction on the first virtual boundary; the first enlarged view includes a segment of the first virtual boundary stroked by the stroke selection instruction;
in response to the operation instruction for the endpoints, enlarging and displaying a second enlarged view of a second operation area at a second preset position; wherein the second operation area is a preset range area corresponding to a dragging trajectory point of the operation instruction; the second enlarged view includes the corresponding dragging trajectory.

In the above solution, before displaying the first virtual map, the method further includes:
in response to an operation instruction from the user, aligning and overlapping coordinate positions of a displayed first boundary map and a background map to obtain the first virtual map;
wherein the first boundary map includes the first virtual boundary primitives; the background map includes the sketch primitives.

In the above solution, the responding to an operation instruction from the user, aligning and overlapping coordinate positions of a first boundary map and a background map displayed on a home page to obtain the first virtual map, includes:
in response to an overlap display operation instruction from the user, displaying multiple map styles;
in response to a selection instruction from the user for a target style among the multiple map styles, aligning and overlapping coordinate positions of the background map corresponding to the target style and the first boundary map to obtain the first virtual map.

In the above solution, after the responding to an operation instruction from the user, aligning and overlapping coordinate positions of a displayed first boundary map and a background map to obtain the first virtual map, the method further includes:
if the first virtual boundary in the first virtual map is not completely covered by the sketch primitives, performing a first prompt to the user after jumping to a predetermined interface; wherein the first prompt is used to remind the user to refer to the sketch primitives when modifying the first virtual boundary.

In the above solution, the method further includes:
if an area of the first virtual boundary in the first virtual map covering the sketch primitives is less than a predetermined ratio, performing the first prompt to the user after jumping to the predetermined interface.

In the above solution, the method further includes:
in response to the stroke selection instruction from the user for a boundary segment of mixed attributes in the first virtual map, determining the boundary segment of mixed attributes as the boundary segment to be modified; wherein the boundary segment of mixed attributes includes multiple positional relationships with the intelligent mobile device.

In the above solution, after the responding to a stroke selection instruction from the user for the first virtual boundary in the first virtual map, and determining endpoints corresponding to a boundary segment to be modified in the first virtual boundary, the method further includes:
in response to an attribute type selection instruction from the user for the boundary segment to be modified, displaying multiple attribute type styles;
in response to a selection instruction from the user for a target attribute style among the multiple attribute type styles, modifying a boundary attribute of the boundary segment to be modified to a target boundary attribute corresponding to the target attribute style.

In the above solution, the method further includes:
if it is detected that the second virtual boundary in the second virtual map is abnormal, performing a second prompt to the user.

In the above solution, the if it is detected that the second virtual boundary in the second virtual map is abnormal, performing a second prompt to the user, includes any one of the following:
if it is detected that the N target virtual boundary segments in the second virtual boundary self-intersect, performing the second prompt to the user;
if it is detected that the second virtual boundary intersects a preset functional area, performing the second prompt to the user.

An embodiment of the present disclosure further provides a method for device control, applied to an intelligent mobile device, including:
obtaining a second virtual map, and working based on the second virtual map;
wherein the second virtual map is determined by a client in response to a modification instruction from a user for a first virtual boundary in a displayed first virtual map; the first virtual map includes sketch primitives and first virtual boundary primitives; the first virtual boundary primitives are used to represent a first virtual boundary; an area enclosed by the first virtual boundary is used to indicate a working area of the intelligent mobile device; a positional relationship between the sketch primitives and the first virtual boundary primitives in the first virtual map is used to provide a visual reference; position information of the sketch primitives is obtained by scanning when a scanning device works within a range of 0-20 m above ground in the working area.

An embodiment of the present disclosure further provides an apparatus for map modification, applied to a client, including:
a display module configured to display a first virtual map; wherein the first virtual map includes sketch primitives and first virtual boundary primitives; the first virtual boundary primitives are used to represent a first virtual boundary; an area enclosed by the first virtual boundary is used to indicate a working area of an intelligent mobile device; a positional relationship between the sketch primitives and the first virtual boundary primitives in the first virtual map is used to provide a visual reference; position information of the sketch primitives is obtained by scanning when a scanning device works within a range of 0-20 m above ground in the working area;
a modification module configured to, in response to a modification instruction from a user for the first virtual boundary in the first virtual map, display a modified second virtual map including a modified target working area.

An embodiment of the present disclosure further provides a device control apparatus, applied to an intelligent mobile device, including:
an acquisition module configured to obtain a second virtual map, and work based on the second virtual map;
wherein the second virtual map is determined by a client in response to a modification instruction from a user for a first virtual boundary in a displayed first virtual map; the first virtual map includes sketch primitives and first virtual boundary primitives representing a first virtual boundary; an area enclosed by the first virtual boundary is used to indicate a working area of the intelligent mobile device; a positional relationship between the sketch primitives and the first virtual boundary primitives in the first virtual map is used to provide a visual reference; position information of the sketch primitives is obtained by scanning when a scanning device works within a range of 0-20 m above ground in the working area.

An embodiment of the present disclosure provides a method for map modification, applied to a client, the method including:
displaying at least a first map style and a second map style, wherein a color or identification pattern representing grass and non-grass in the first map style is different from that in the second map style, and the first map style and the second map style at least include boundary primitives;
detecting a touch event acting on the first map style, then displaying a first virtual map corresponding to the first map style, the first virtual map including first virtual boundary primitives representing a first virtual boundary, an area enclosed by the first virtual boundary being used to indicate a working area of an intelligent mobile device.

In the above solution, the detecting a touch event acting on a first map style, then displaying a first virtual map corresponding to the first map style, includes: detecting a touch event acting on a first map style, aligning and overlapping coordinate positions of a background map corresponding to the first map style and a first boundary map to obtain the first virtual map, the first boundary map including the first virtual boundary primitives; displaying the first virtual map.

In the above solution, the first map style is a style that displays the boundary primitives and the background map, and the second map style is a style that displays only the boundary primitives.

In the above solution, the background map corresponding to the first map style is obtained according to scanning point cloud data obtained by a scanning device working within a range of 0-20 m above ground in the working area, and/or the first virtual map is obtained according to scanning point cloud data obtained by a scanning device working within a range of 0-20 m above ground in the working area.

In the above solution, the first boundary map and the background map are displayed on a home page or a map editing page.

In the above solution, before displaying the first virtual map, the method further includes: determining a color of each area within the first boundary map based on a color of the background map.

In the above solution, after the detecting a touch event acting on a first map style, aligning and overlapping coordinate positions of a background map corresponding to the first map style and a first boundary map to obtain the first virtual map, the method further includes: if the first virtual boundary in the first virtual map is not completely covered by sketch primitives, performing a first prompt to the user after jumping to a predetermined interface; wherein the first prompt is used to remind the user to refer to the sketch primitives when modifying the first virtual boundary.

In the above solution, the area enclosed by the first virtual boundary is obtained by dividing based on obstacles and grass of the intelligent mobile device, or is a preset area by the user.

In the above solution, after displaying the first virtual map, the method further includes: in response to a modification instruction from the user for the first virtual boundary in the first virtual map, displaying a second virtual map.

In the above solution, the responding to a modification instruction from the user for the first virtual boundary in the first virtual map, and displaying a second virtual map, includes: in response to a stroke selection instruction from the user for the first virtual boundary in the first virtual map, determining endpoints corresponding to a boundary segment to be modified in the first virtual boundary; in response to an operation instruction from the user based on the endpoints, forming a target virtual boundary segment; determining a second virtual boundary based on the target virtual boundary segment and an unmodified boundary segment, obtaining the second virtual map for display; wherein the unmodified boundary segment is a part of the first virtual boundary other than the boundary to be modified.

In the above solution, the target virtual boundary segment includes: N target virtual boundary segments; the responding to an operation instruction from the user based on the endpoints, forming a target virtual boundary segment, includes: obtaining N dragging trajectories from the user starting from the endpoints in the first virtual map, and forming N target virtual boundary segments based on the N dragging trajectories; wherein N is an integer greater than 0; the N dragging trajectories are connected end to end.

In the above solution, the method further includes: detecting that the stroke selection instruction is terminated during a stroking process of the user, and forming a straight line between the two endpoints according to the stroke selection instruction; in response to a confirmation instruction from the user, determining that the straight line together with the unmodified boundary segment forms the target virtual boundary segment.

In the above solution, before obtaining an M-th dragging trajectory of the user in the first virtual map; wherein M is any integer from 1 to N; the method further includes: in response to a boundary attribute selection instruction from the user for the M-th dragging trajectory, determining a boundary attribute of an M-th target virtual boundary segment corresponding to the M-th dragging trajectory.

In the above solution, the responding to an operation instruction from the user based on the endpoints, forming a target virtual boundary, includes: obtaining a dragging trajectory between the endpoints from the user in the first virtual map; forming the target virtual boundary segment based on a movement trajectory indicated by a movement operation instruction from the user for the endpoints, and the dragging trajectory.

In the above solution, the method further includes: in response to the stroke selection instruction, enlarging and displaying a first enlarged view of a first operation area at a first preset position; wherein the first operation area is a preset range area corresponding to an operation point of the stroke selection instruction on the first virtual boundary; the first enlarged view includes a segment of the first virtual boundary stroked by the stroke selection instruction; in response to the operation instruction for the endpoints, enlarging and displaying a second enlarged view of a second operation area at a second preset position; wherein the second operation area is a preset range area corresponding to a dragging trajectory point of the operation instruction; the second enlarged view includes the corresponding dragging trajectory.

In the above solution, the method further includes: in response to the stroke selection instruction from the user for a boundary segment of mixed attributes in the first virtual map, determining the boundary segment of mixed attributes as the boundary segment to be modified; wherein the boundary segment of mixed attributes includes multiple positional relationships with the intelligent mobile device.

In the above solution, after the responding to a stroke selection instruction from the user for the first virtual boundary in the first virtual map, and determining endpoints corresponding to a boundary segment to be modified in the first virtual boundary, the method further includes: in response to an attribute type selection instruction from the user for the boundary segment to be modified, displaying multiple attribute type styles; in response to a selection instruction from the user for a target attribute style among the multiple attribute type styles, modifying a boundary attribute of the boundary segment to be modified to a target boundary attribute corresponding to the target attribute style.

In the above solution, the method further includes: if it is detected that the second virtual boundary in the second virtual map is abnormal, performing a second prompt to the user.

In the above solution, the if it is detected that the second virtual boundary in the second virtual map is abnormal, performing a second prompt to the user, includes any one of the following: if it is detected that the N target virtual boundary segments in the second virtual boundary self-intersect, performing the second prompt to the user; if it is detected that the second virtual boundary intersects a preset functional area, performing the second prompt to the user.

An embodiment of the present disclosure further provides a method for device control, applied to an intelligent mobile device, including:
obtaining a second virtual map, and working based on the second virtual map;
wherein the second virtual map is determined by a client in response to a modification instruction from a user for a first virtual boundary in a displayed first virtual map, and the first virtual map is a virtual map determined by the client after displaying a first map style and a second map style, corresponding to the first map style; a color or identification pattern representing grass and non-grass in the first map style is different from that in the second map style, and the first map style and the second map style at least include boundary primitives; the first virtual map includes first virtual boundary primitives representing a first virtual boundary, an area enclosed by the first virtual boundary being used to indicate a working area of the intelligent mobile device.

An embodiment of the present disclosure further provides an apparatus for map modification, applied to a client, including a display module and a processing module, wherein,
the display module is configured to display at least a first map style and a second map style, wherein a color or identification pattern representing grass and non-grass in the first map style is different from that in the second map style, and the first map style and the second map style at least include boundary elements;
the processing module is configured to, upon detecting a touch event acting on the first map style, display a first virtual map corresponding to the first map style, the first virtual map including first virtual boundary primitives representing a first virtual boundary, an area enclosed by the first virtual boundary being used to indicate a working area of an intelligent mobile device.

An embodiment of the present disclosure further provides a device control apparatus, applied to an intelligent mobile device, including:
an acquisition module configured to obtain a second virtual map, and work based on the second virtual map;
wherein the second virtual map is determined by a client in response to a modification instruction from a user for a first virtual boundary in a displayed first virtual map, and the first virtual map is a virtual map determined by the client after displaying a first map style and a second map style, corresponding to the first map style; a color or identification pattern representing grass and non-grass in the first map style is different from that in the second map style, and the first map style and the second map style at least include boundary primitives; the first virtual map includes first virtual boundary primitives representing a first virtual boundary, an area enclosed by the first virtual boundary being used to indicate a working area of the intelligent mobile device.

An embodiment of the present disclosure further provides a method for map modification, applied to a client, including:
displaying a first virtual map; wherein the first virtual map includes a first virtual boundary, an area enclosed by the first virtual boundary being used to indicate a working area of an intelligent mobile device;
in response to a selection instruction from a user, determining a boundary segment to be modified in the first virtual boundary;
in response to a boundary attribute type modification instruction from the user for the boundary segment to be modified, modifying a boundary attribute of the boundary segment to be modified to form a second virtual map; wherein the boundary attribute is used to indicate a positional relationship between the intelligent mobile device and the first virtual boundary, or a positional relationship between the intelligent mobile device and a physical boundary corresponding to the first virtual boundary.

In the above solution, the boundary attribute includes: a straddling travel attribute, a boundary-inside edge travel attribute, and a boundary-outside edge travel attribute; the straddling travel attribute represents that the physical boundary is lower than a chassis of a lawn mower, and there is no dangerous object outside the physical boundary; the boundary-inside edge travel attribute represents that the physical boundary is higher than the chassis of the lawn mower; the boundary-outside edge travel attribute represents that the physical boundary is lower than the chassis of the lawn mower, and an area outside the physical boundary is a grassy area that can be traveled on.

In the above solution, the responding to a boundary attribute type modification instruction from the user for the boundary segment to be modified, modifying a boundary attribute of the boundary segment to be modified to form a second virtual map, includes:
in response to the boundary attribute type modification instruction from the user for the boundary segment to be modified, modifying the boundary attribute of the boundary segment to be modified to a target boundary attribute to form a target virtual boundary segment;
determining a modified second virtual map based on the target virtual boundary segment and an unmodified boundary segment for display; wherein the unmodified boundary segment is a part of the first virtual boundary other than the boundary to be modified.

In the above solution, the responding to a boundary attribute type modification instruction from the user for the boundary segment to be modified, modifying the boundary attribute of the boundary segment to be modified to a first boundary attribute to form a target virtual boundary segment, includes:
in response to the boundary attribute type modification instruction from the user for the boundary segment to be modified, displaying multiple attribute type styles;
in response to a selection instruction from the user for a target attribute style among the multiple attribute type styles, modifying the boundary attribute of the boundary segment to be modified to the target boundary attribute corresponding to the target attribute style, to form the target virtual boundary segment.

In the above solution, the first virtual map further includes sketch primitives, a positional relationship between the sketch primitives and first virtual boundary primitives in the first virtual map is used to provide a visual reference; position information of the sketch primitives is obtained by scanning when a scanning device works within a range of 0-20 m above ground in the working area.

In the above solution, the first virtual map further displays a range or area information of the sketch primitives, and physical boundary height information.

In the above solution, the method includes: a lawn mower automatically setting a boundary attribute according to a range or area information of grass and non-grass obtained by a scanning device, and physical boundary height information.

In the above solution, the method further includes one of the following:
in response to an operation instruction from the user, aligning and overlapping coordinate positions of a displayed first boundary map and a background map to obtain the first virtual map; wherein the first boundary map includes first virtual boundary primitives representing the first virtual boundary; the background map includes sketch primitives; a positional relationship between the sketch primitives and the first virtual boundary primitives in the first virtual map is used to provide a visual reference;
in response to an operation instruction from the user, determining the first boundary map as the first virtual map.

In the above solution, the method further includes: modifying different attributes of the first virtual boundary to a same attribute.

In the above solution, the responding to an operation instruction from the user, aligning and overlapping coordinate positions of the displayed first boundary map and a background map to obtain a first virtual map, includes:
in response to an overlap display operation instruction from the user, displaying multiple map styles;
in response to a selection instruction from the user for a target style among the multiple map styles, aligning and overlapping coordinate positions of the background map corresponding to the target style and the first boundary map to obtain the first virtual map.

In the above solution, after the responding to an operation instruction from the user, aligning and overlapping coordinate positions of a displayed first boundary map and a background map to obtain the first virtual map, the method further includes:
if the first virtual boundary in the first virtual map is not completely covered by the sketch primitives, performing a first prompt to the user after jumping to a predetermined interface; wherein the first prompt is used to remind the user to refer to the sketch primitives when modifying the first virtual boundary.

In the above solution, the responding to a selection instruction from a user, determining a boundary segment to be modified in the first virtual boundary, includes:
in response to a stroke selection instruction from the user for the first virtual boundary in the first virtual map, determining the boundary segment to be modified, and a first endpoint and a second endpoint corresponding to the boundary segment to be modified, in the first virtual boundary.

In the above solution, the method further includes:
in response to a dragging operation instruction from the user based on the first endpoint and the second endpoint, obtaining a dragging trajectory between the first endpoint and the second endpoint from the user;
generating a target virtual boundary segment based on the first endpoint, the dragging trajectory and the second endpoint.

In the above solution, the generating a target virtual boundary segment based on the first endpoint, the dragging trajectory and the second endpoint, includes:
forming the target virtual boundary segment based on a movement trajectory indicated by a movement operation instruction from the user for the first endpoint and/or the second endpoint, and the dragging trajectory.

In the above solution, the target virtual boundary segment includes: N target virtual boundary segments; the method further includes:
obtaining N dragging trajectories from the user starting from any endpoint in the first virtual map, and forming N target virtual boundary segments based on the N dragging trajectories; wherein N is an integer greater than 0; the N dragging trajectories are connected end to end.

In the above solution, before obtaining an M-th dragging trajectory of the user in the first virtual map; wherein M is any integer from 1 to N; the method further includes:
in response to a boundary attribute selection instruction from the user for the M-th dragging trajectory, determining a boundary attribute of an M-th target virtual boundary segment corresponding to the M-th dragging trajectory.

In the above solution, the method further includes:
in response to the stroke selection instruction, enlarging and displaying a first enlarged view of a first operation area at a first preset position; wherein the first operation area is a preset range area corresponding to an operation point of the stroke selection instruction on the first virtual boundary; the first enlarged view includes a segment of the first virtual boundary stroked by the stroke selection instruction;
in response to the dragging operation instruction, enlarging and displaying a second enlarged view of a second operation area at a second preset position; wherein the second operation area is a preset range area corresponding to a dragging trajectory point of the dragging operation instruction; the second enlarged view includes the corresponding dragging trajectory.

In the above solution, the method further includes:
in response to the stroke selection instruction from the user for a boundary segment of mixed attributes in the first virtual map, determining the boundary segment of mixed attributes as the boundary segment to be modified; wherein the boundary segment of mixed attributes includes multiple positional relationships with the intelligent mobile device.

In the above solution, the method further includes:
if it is detected that a second virtual boundary in the second virtual map is abnormal, performing a second prompt to the user.

In the above solution, the if it is detected that a second virtual boundary in the second virtual map is abnormal, performing a second prompt to the user, includes any one of the following:
if it is detected that N target virtual boundary segments in the second virtual boundary self-intersect, performing the second prompt to the user;
if it is detected that the second virtual boundary intersects a preset functional area, performing the second prompt to the user.

An embodiment of the present disclosure further provides a method for device control, applied to an intelligent mobile device, including:
obtaining a second virtual map, and working based on the second virtual map;
wherein the second virtual map is formed by a client, in response to a selection instruction from a user for a displayed first virtual map, selecting a boundary segment to be modified, and in response to a boundary attribute type modification instruction from the user for the boundary segment to be modified, modifying a boundary attribute of the boundary segment to be modified; the first virtual map includes a first virtual boundary, an area enclosed by the first virtual boundary being used to indicate a working area of the intelligent mobile device; the boundary attribute is used to indicate a positional relationship between the intelligent mobile device and the first virtual boundary, or a positional relationship between the intelligent mobile device and a physical boundary corresponding to the first virtual boundary.

An embodiment of the present disclosure further provides an apparatus for map modification, applied to a client, including:
a display module configured to display a first virtual map; wherein the first virtual map includes a first virtual boundary, an area enclosed by the first virtual boundary being used to indicate a working area of an intelligent mobile device;
a response module configured to, in response to a selection instruction from a user, determine a boundary segment to be modified in the first virtual boundary;
the response module further configured to, in response to a boundary attribute type modification instruction from the user for the boundary segment to be modified, modify a boundary attribute of the boundary segment to be modified to form a second virtual map; wherein the boundary attribute is used to indicate a positional relationship between the intelligent mobile device and the first virtual boundary, or a positional relationship between the intelligent mobile device and a physical boundary corresponding to the first virtual boundary.

An embodiment of the present disclosure further provides a device control apparatus, applied to an intelligent mobile device, including:
an acquisition module configured to obtain a second virtual map, and work based on the second virtual map;
wherein the second virtual map is formed by a client, in response to a selection instruction from a user for a displayed first virtual map, selecting a boundary segment to be modified, and in response to a boundary attribute type modification instruction from the user for the boundary segment to be modified, modifying a boundary attribute of the boundary segment to be modified; the first virtual map includes a first virtual boundary, an area enclosed by the first virtual boundary being used to indicate a working area of the intelligent mobile device; the boundary attribute is used to indicate a positional relationship between the intelligent mobile device and the first virtual boundary, or a positional relationship between the intelligent mobile device and a physical boundary corresponding to the first virtual boundary.

An embodiment of the present disclosure provides a method for map modification, including:
displaying a first virtual map in an interactive page; wherein the first virtual map includes a first virtual boundary, a first boundary map includes primitives representing the first virtual boundary, an area enclosed by the first virtual boundary being used to indicate a working area of an intelligent mobile device;
detecting a first touch event acting on the first virtual boundary, and determining a coordinate point in the first boundary map corresponding to a touch point according to the touch point of the first touch event;
enlarging and displaying a preset area containing the coordinate point in the first boundary map at a preset position of the interactive page, to obtain a partial enlarged view.

In the above solution, the first virtual map further includes sketch primitives.

In the above solution, the coordinate point is at a center of the partial enlarged view, and the partial enlarged view further includes a portion of the first virtual boundary connected to the coordinate point.

In the above solution, the preset area is an area with a first radius length centered at the coordinate point.

In the above solution, an enlargement ratio of the partial enlarged view is adjustable.

In the above solution, the preset position and the preset area are distributed in different areas of the interactive page.

In the above solution, an enlarged area in the partial enlarged view includes a boundary segment to be modified connected to the coordinate point.

In the above solution, a boundary segment on another side connected to the coordinate point that is not selected is not displayed in the partial enlarged view.

In the above solution, the first virtual map further includes sketch primitives, position information of the sketch primitives is obtained by scanning when a scanning device works within a range of 0-20 m above ground in the working area.

In the above solution, the method further includes one of the following:
in response to an operation instruction from the user, aligning and overlapping coordinate positions of a displayed first boundary map and a background map to obtain the first virtual map; wherein the first boundary map includes first virtual boundary primitives representing the first virtual boundary; the background map includes work object primitives; a positional relationship between the work object primitives and the first virtual boundary primitives in the first virtual map is used to provide a visual reference;
in response to an operation instruction from the user, determining the first boundary map as the first virtual map.

In the above solution, the responding to an operation instruction from the user, aligning and overlapping coordinate positions of the displayed first boundary map and a background map to obtain a first virtual map, includes:
in response to an overlap display operation instruction from the user, displaying multiple map styles;
in response to a selection instruction from the user for a target style among the multiple map styles, aligning and overlapping coordinate positions of the background map corresponding to the target style and the first boundary map to obtain the first virtual map.

In the above solution, after the responding to an operation instruction from the user, aligning and overlapping coordinate positions of the displayed first boundary map and a background map to obtain the first virtual map, the method further includes:
if the first virtual boundary in the first virtual map is not completely covered by the work object primitives, performing a first prompt to the user after jumping to a predetermined interface; wherein the first prompt is used to remind the user to refer to the work object primitives when modifying the first virtual boundary.

In the above solution, the method further includes:
responding to a touch event acting on the first virtual boundary, and based on a stroke selection instruction for the first virtual boundary in the first virtual map in the touch event, determining the boundary segment to be modified, and a first endpoint and a second endpoint corresponding to the boundary segment to be modified, in the first virtual boundary.

In the above solution, the method further includes:
in response to a dragging operation instruction from the user based on the first endpoint and the second endpoint, obtaining a dragging trajectory between the first endpoint and the second endpoint from the user;
generating a target virtual boundary segment based on the first endpoint, the dragging trajectory and the second endpoint;
determining a modified second virtual map based on the target virtual boundary segment and an unmodified boundary segment for display; wherein the unmodified boundary segment is a part of the first virtual boundary other than the boundary to be modified.

In the above solution, the generating a target virtual boundary segment based on the first endpoint, the dragging trajectory and the second endpoint, includes:
forming the target virtual boundary segment based on a movement trajectory indicated by a movement operation instruction from the user for the first endpoint and/or the second endpoint, and the dragging trajectory.

In the above solution, the target virtual boundary segment includes: N target virtual boundary segments; the method further includes:
obtaining N dragging trajectories from the user starting from any endpoint in the first virtual map, and forming N target virtual boundary segments based on the N dragging trajectories; wherein N is an integer greater than 0; the N dragging trajectories are connected end to end.

In the above solution, before obtaining an M-th dragging trajectory of the user in the first virtual map; wherein M is any integer from 1 to N; the method further includes:
in response to a boundary attribute selection instruction from the user for the M-th dragging trajectory, determining a boundary attribute of an M-th target virtual boundary segment corresponding to the M-th dragging trajectory.

In the above solution, the method further includes:
in response to the stroke selection instruction, enlarging and displaying a first enlarged view of a first operation area at a first preset position; wherein the first operation area is a preset range area corresponding to an operation point of the stroke selection instruction on the first virtual boundary; the first enlarged view includes a segment of the first virtual boundary stroked by the stroke selection instruction;
in response to the dragging operation instruction, enlarging and displaying a second enlarged view of a second operation area at a second preset position; wherein the second operation area is a preset range area corresponding to a dragging trajectory point of the dragging operation instruction; the second enlarged view includes the corresponding dragging trajectory.

In the above solution, the method further includes:
in response to the stroke selection instruction from the user for a boundary segment of mixed attributes in the first virtual map, determining the boundary segment of mixed attributes as the boundary segment to be modified; wherein the boundary segment of mixed attributes includes multiple positional relationships with the intelligent mobile device.

In the above solution, the method further includes:
in response to an attribute type selection instruction from the user for the boundary segment to be modified, displaying multiple attribute type styles;
in response to a selection instruction from the user for a target attribute style among the multiple attribute type styles, modifying a boundary attribute of the boundary segment to be modified to a target boundary attribute corresponding to the target attribute style.

In the above solution, the method further includes:
if it is detected that a second virtual boundary in the second virtual map is abnormal, performing a second prompt to the user.

In the above solution, the if it is detected that a second virtual boundary in the second virtual map is abnormal, performing a second prompt to the user, includes any one of the following:
if it is detected that N target virtual boundary segments in the second virtual boundary self-intersect, performing the second prompt to the user;
if it is detected that the second virtual boundary intersects a preset functional area, performing the second prompt to the user.

An embodiment of the present disclosure further provides a method for device control, applied to an intelligent mobile device, including:
obtaining a first virtual map, and working based on a first virtual boundary in the first virtual map;
wherein the first virtual map is obtained by a client displaying a first virtual map in an interactive page; wherein the first virtual map includes a first virtual boundary, a first boundary map includes primitives representing the first virtual boundary, an area enclosed by the first virtual boundary being used to indicate a working area of the intelligent mobile device; detecting a first touch event acting on the first virtual boundary, determining a coordinate point in the first boundary map corresponding to a touch point according to the touch point of the first touch event; enlarging and displaying a preset area containing the coordinate point in the first boundary map at a preset position of the interactive page, to obtain a partial enlarged view.

An embodiment of the present disclosure further provides an apparatus for map modification, applied to a client, including:
a display module configured to display a first virtual map in an interactive page; wherein the first virtual map includes a first virtual boundary, a first boundary map includes primitives representing the first virtual boundary, an area enclosed by the first virtual boundary being used to indicate a working area of an intelligent mobile device;
a detection module configured to detect a first touch event acting on the first virtual boundary, and determine a coordinate point in the first boundary map corresponding to a touch point according to the touch point of the first touch event;
an enlargement module configured to enlarge and display a preset area containing the coordinate point in the first boundary map at a preset position of the interactive page, to obtain a partial enlarged view.

An embodiment of the present disclosure further provides a device control apparatus, applied to an intelligent mobile device, including:
an acquisition module configured to obtain a first virtual map, and work based on a first virtual boundary in the first virtual map;
wherein the first virtual map is obtained by a client displaying a first virtual map in an interactive page; wherein the first virtual map includes a first virtual boundary, a first boundary map includes primitives representing the first virtual boundary, an area enclosed by the first virtual boundary being used to indicate a working area of the intelligent mobile device; detecting a first touch event acting on the first virtual boundary, determining a coordinate point in the first boundary map corresponding to a touch point according to the touch point of the first touch event; enlarging and displaying a preset area containing the coordinate point in the first boundary map at a preset position of the interactive page, to obtain a partial enlarged view.

An embodiment of the present disclosure provides a method for map modification, including:
displaying a first virtual map; wherein the first virtual map includes a first virtual boundary, an area enclosed by the first virtual boundary being used to indicate a working area of an intelligent mobile device;
in response to a selection instruction from a user, determining endpoints of a boundary segment to be modified in the first virtual boundary;
forming a target virtual boundary segment based on the endpoints and a dragging operation instruction from the user between the endpoints;
determining a modified second virtual map based on the target virtual boundary segment and an unmodified boundary segment for display; wherein the unmodified boundary segment is a part of the first virtual boundary other than the boundary to be modified.

In the above solution, the first virtual map further includes sketch primitives, position information of the sketch primitives is obtained by scanning when a scanning device works within a range of 0-20 m above ground in the working area, and a positional relationship between the sketch primitives and first virtual boundary primitives in the first virtual map is used to provide a visual reference.

In the above solution, the responding to a selection instruction from a user, determining endpoints of a boundary segment to be modified in the first virtual boundary, includes:
in response to a stroke selection instruction from the user for the first virtual boundary in the first virtual map, determining a first endpoint and a second endpoint corresponding to the boundary segment to be modified in the first virtual boundary.

In the above solution, the forming a target virtual boundary segment based on the endpoints and a dragging operation instruction from the user between the endpoints, includes:
responding to the dragging operation instruction, obtaining a dragging trajectory between the first endpoint and the second endpoint from the user;
generating the target virtual boundary segment based on the first endpoint, the dragging trajectory and the second endpoint.

In the above solution, the generating the target virtual boundary segment based on the first endpoint, the dragging trajectory and the second endpoint, includes:
forming the target virtual boundary segment based on a movement trajectory indicated by a movement operation instruction from the user for the first endpoint and/or the second endpoint, and the dragging trajectory.

In the above solution, the target virtual boundary segment includes: N target virtual boundary segments; the method further includes:
obtaining N dragging trajectories from the user starting from any of the endpoints in the first virtual map, and forming N target virtual boundary segments based on the N dragging trajectories; wherein N is an integer greater than 0; the N dragging trajectories are connected end to end.

In the above solution, the method further includes:
detecting that the stroke selection instruction is terminated during a stroking process of the user, and forming a straight line between the first endpoint and the second endpoint according to the stroke selection instruction;
in response to a confirmation instruction from the user, determining that the straight line together with the unmodified boundary segment forms the target virtual boundary segment.

In the above solution, before obtaining an M-th dragging trajectory of the user in the first virtual map; wherein M is any integer from 1 to N; the method further includes:
in response to a boundary attribute selection instruction from the user for the M-th dragging trajectory, determining a boundary attribute of an M-th target virtual boundary segment corresponding to the M-th dragging trajectory.

In the above solution, the method further includes one of the following:
in response to an operation instruction from the user, aligning and overlapping coordinate positions of a displayed first boundary map and a background map to obtain the first virtual map; wherein the first boundary map includes first virtual boundary primitives representing the first virtual boundary; the background map includes sketch primitives; a positional relationship between the sketch primitives and the first virtual boundary primitives in the first virtual map is used to provide a visual reference;
in response to an operation instruction from the user, determining the first boundary map as the first virtual map.

In the above solution, the responding to an operation instruction from the user, aligning and overlapping coordinate positions of the displayed first boundary map and a background map to obtain a first virtual map, includes:
in response to an overlap display operation instruction from the user, displaying multiple map styles;
in response to a selection instruction from the user for a target style among the multiple map styles, aligning and overlapping coordinate positions of the background map corresponding to the target style and the first virtual map to obtain the first virtual map.

In the above solution, after the responding to an operation instruction from the user, aligning and overlapping coordinate positions of the displayed first boundary map and a background map to obtain the first virtual map, the method further includes:
if the first virtual boundary in the first virtual map is not completely covered by the sketch primitives, performing a first prompt to the user after jumping to a predetermined interface; wherein the first prompt is used to remind the user to refer to the sketch primitives when modifying the first virtual boundary.

In the above solution, the method further includes:
if an area of the first virtual boundary in the first virtual map covering the sketch primitives is less than a predetermined ratio, performing a first prompt to the user after jumping to the predetermined interface.

In the above solution, the method further includes:
in response to the stroke selection instruction, enlarging and displaying a first enlarged view of a first operation area at a first preset position; wherein the first operation area is a preset range area corresponding to an operation point of the stroke selection instruction on the first virtual boundary; the first enlarged view includes a segment of the first virtual boundary stroked by the stroke selection instruction;
in response to the dragging operation instruction, enlarging and displaying a second enlarged view of a second operation area at a second preset position; wherein the second operation area is a preset range area corresponding to a dragging trajectory point of the dragging operation instruction; the second enlarged view includes the corresponding dragging trajectory.

In the above solution, the method further includes:
in response to the stroke selection instruction from the user for a boundary segment of mixed attributes in the first virtual map, determining the boundary segment of mixed attributes as the boundary segment to be modified; wherein the boundary segment of mixed attributes includes multiple positional relationships with the intelligent mobile device.

In the above solution, the method further includes:
in response to an attribute type selection instruction from the user for the boundary segment to be modified, displaying multiple attribute type styles;
in response to a selection instruction from the user for a target attribute style among the multiple attribute type styles, modifying a boundary attribute of the boundary segment to be modified to a target boundary attribute corresponding to the target attribute style.

In the above solution, the method further includes:
if it is detected that a second virtual boundary in the second virtual map is abnormal, performing a second prompt to the user.

In the above solution, the if it is detected that a second virtual boundary in the second virtual map is abnormal, performing a second prompt to the user, includes any one of the following:
if it is detected that N target virtual boundary segments in the second virtual boundary self-intersect, performing the second prompt to the user;
if it is detected that the second virtual boundary intersects a preset functional area, performing the second prompt to the user.

An embodiment of the present disclosure further provides a method for device control, applied to an intelligent mobile device, including:
obtaining a second virtual map, and working based on the second virtual map;
wherein the second virtual map is determined by a client, in response to a selection instruction from a user for a displayed first virtual map, selecting endpoints of a boundary segment to be modified, forming a target virtual boundary segment and an unmodified boundary segment based on the endpoints and a dragging operation instruction from the user between the endpoints; the unmodified boundary segment is a part of the first virtual boundary other than the boundary to be modified; the first virtual map includes a first virtual boundary, an area enclosed by the first virtual boundary being used to indicate a working area of the intelligent mobile device.

An embodiment of the present disclosure further provides an apparatus for map modification, applied to a client, including:
a display module configured to display a first virtual map; wherein the first virtual map includes a first virtual boundary, an area enclosed by the first virtual boundary being used to indicate a working area of an intelligent mobile device;
a response module configured to, in response to a selection instruction from a user, determine endpoints of a boundary segment to be modified in the first virtual boundary;
a forming module configured to form a target virtual boundary segment based on the endpoints and a dragging operation instruction from the user between the endpoints;
a determination module configured to determine a modified second virtual map based on the target virtual boundary segment and an unmodified boundary segment for display; wherein the unmodified boundary segment is a part of the first virtual boundary other than the boundary to be modified.

An embodiment of the present disclosure further provides a device control apparatus, applied to an intelligent mobile device, including:
an acquisition module configured to obtain a second virtual map, and work based on the second virtual map;
wherein the second virtual map is determined by a client, in response to a selection instruction from a user for a displayed first virtual map, selecting endpoints of a boundary segment to be modified, forming a target virtual boundary segment and an unmodified boundary segment based on the endpoints and a dragging operation instruction from the user between the endpoints; the unmodified boundary segment is a part of the first virtual boundary other than the boundary to be modified; the first virtual map includes a first virtual boundary, an area enclosed by the first virtual boundary being used to indicate a working area of the intelligent mobile device.

An embodiment of the present disclosure further provides an electronic device, including a first memory and a first processor, the first memory storing a computer program executable on the first processor, wherein the first processor executes the computer program to implement the steps in the method on a client side.

An embodiment of the present disclosure further provides an electronic device, including a second memory and a second processor, the second memory storing a computer program executable on the second processor, wherein the second processor executes the computer program to implement the steps in the method on an intelligent mobile device side.

An embodiment of the present disclosure further provides a computer-readable storage medium, having a computer program stored thereon, wherein the computer program, when executed by a first processor, implements the steps in the method on a client side.

An embodiment of the present disclosure further provides a computer-readable storage medium, having a computer program stored thereon, wherein the computer program, when executed by a second processor, implements the steps in the method on an intelligent mobile device side.

An embodiment of the present disclosure further provides a computer program product, including a computer program, wherein the computer program, when executed by a first processor, implements the steps in the method on a client side.

An embodiment of the present disclosure further provides a computer program product, including a computer program, wherein the computer program, when executed by a second processor, implements the steps in the method on an intelligent mobile device side.

In the embodiments of the present disclosure, a first virtual map is displayed; wherein the first virtual map includes sketch primitives and first virtual boundary primitives; the first virtual boundary primitives are used to represent a first virtual boundary; an area enclosed by the first virtual boundary is used to indicate a working area of an intelligent mobile device; a positional relationship between the sketch primitives and the first virtual boundary primitives in the first virtual map is used to provide a visual reference; position information of the sketch primitives is obtained by scanning when a scanning device works within a range of 0-20 m above ground in the working area; in response to a modification instruction from a user for the first virtual boundary in the first virtual map, displaying a modified second virtual map. Thus, because the positional relationship between the sketch primitives and the first virtual boundary primitives in the first virtual map is used to provide a visual reference for the user, the user can accurately modify and adjust the first virtual boundary according to the positional relationship between the sketch primitives and the first virtual boundary primitives in the first virtual map, thereby obtaining a second virtual map with relatively high boundary accuracy. After the intelligent mobile device works using the second virtual map with relatively high boundary accuracy as a reference, the boundary mowing coverage of the intelligent mobile device can be improved.

It should be understood that the phrase “one embodiment” or “an embodiment” throughout the specification means that a particular feature, structure, or characteristic related to the embodiment is included in at least one embodiment of the present disclosure. Therefore, the phrase “in one embodiment” or “in an embodiment” appearing throughout the specification does not necessarily refer to the same embodiment. Furthermore, these particular features, structures, or characteristics may be combined in any suitable manner in one or more embodiments. It should be understood that in the various embodiments of the present disclosure, the sequence numbers of the above processes do not imply a particular order of execution. The execution order of the processes should be determined by their functions and internal logic, and should not constitute any limitation on the implementation process of the embodiments of the present disclosure. The above sequence numbers of the embodiments of the present disclosure are for description only and do not represent the superiority or inferiority of the embodiments.

It should be noted that, as used herein, the terms “includes,” “including,” or any other variation thereof are intended to cover a non-exclusive inclusion, such that a process, method, article, or apparatus that includes a list of elements includes not only those elements but also other elements not expressly listed, or also includes elements inherent to such process, method, article, or apparatus. Without further limitation, an element defined by the phrase “including a . . . ” does not exclude the presence of additional identical elements in the process, method, article, or apparatus that includes the element.

In the several embodiments provided in the present disclosure, it should be understood that the disclosed apparatus and method may be implemented in other ways. The apparatus embodiments described above are merely illustrative. For example, the division of modules is merely a logical functional division, and there may be other ways of division in actual implementation. For example, multiple modules or components may be combined or integrated into another system, or some features may be omitted or not performed. In addition, the coupling, direct coupling, or communication connection between the components shown or discussed may be indirect coupling or communication connection through some interfaces, devices, or modules, and may be electrical, mechanical, or other forms.

The modules described above as separate components may or may not be physically separate. The components displayed as modules may or may not be physical modules; they may be located in one place or distributed across multiple network modules; some or all of the modules may be selected according to actual needs to achieve the purpose of the solution of this embodiment.

In addition, each functional module in each embodiment of the present disclosure may be integrated into one processing module, or each module may exist separately physically, or two or more modules may be integrated into one module; the above integrated modules may be implemented in the form of hardware or in the form of hardware plus software function modules.

A person of ordinary skill in the art can understand that all or part of the steps of the above method embodiments can be implemented by hardware related to program instructions. The aforementioned program can be stored in a computer-readable storage medium. When executed, the program executes the steps including the above method embodiments. The aforementioned storage medium includes: a mobile storage device, a Read Only Memory (ROM), a magnetic disk, an optical disk, and various other media that can store program code.

Alternatively, if the above integrated modules of the present disclosure are implemented in the form of software function modules and sold or used as independent products, they may also be stored in a computer-readable storage medium. Based on such understanding, the technical solution of the embodiments of the present disclosure essentially, or the part contributing to the related art, can be embodied in the form of a software product. The computer software product is stored in a storage medium and includes several instructions for causing a computer device (which may be a personal computer, a server, or a network device, etc.) to execute all or part of the methods described in the various embodiments of the present disclosure. The aforementioned storage medium includes: a mobile storage device, a ROM, a magnetic disk, an optical disk, and various other media that can store program code.

The above description is only the embodiments of the present disclosure, and the protection scope of the present disclosure is not limited thereto. Any changes or substitutions that can be easily conceived by a person skilled in the art within the technical scope disclosed in the present disclosure should be covered by the protection scope of the present disclosure.

1. A method for map modification, applied to a client, comprising:
displaying a first virtual map; wherein the first virtual map comprises a first virtual boundary, and an area enclosed by the first virtual boundary is used to indicate a working area of an intelligent mobile device;
determining endpoints of a boundary segment to be modified in the first virtual boundary, in response to a selection instruction from a user;
forming a target virtual boundary segment based on the endpoints and a dragging operation instruction from the user between the endpoints; and
determining, based on the target virtual boundary segment and an unmodified boundary segment, a modified second virtual map for display; wherein the unmodified boundary segment is a part of the first virtual boundary other than the boundary to be modified.

2. The method for map modification of claim 1, wherein
the first virtual map further comprises sketch primitives, position information of the sketch primitives is obtained by scanning when a scanning device works within a range of 0-20 m above the ground in the working area, and a positional relationship between the sketch primitives and first virtual boundary primitives for representing the first virtual boundary in the first virtual map is used to provide a visual reference.

3. The method for map modification of claim 1, wherein determining the endpoints of the boundary segment to be modified in the first virtual boundary in response to the selection instruction from the user comprises:
determining a first endpoint and a second endpoint corresponding to the boundary segment to be modified in the first virtual boundary, in response to a stroke selection instruction from the user for the first virtual boundary in the first virtual map.

4. The method for map modification of claim 3, wherein forming a target virtual boundary segment based on the endpoints and the dragging operation instruction from the user between the endpoints comprises:
obtaining a dragging trajectory between the first endpoint and the second endpoint from the user, in response to the dragging operation instruction; and
generating the target virtual boundary segment based on the first endpoint, the dragging trajectory and the second endpoint.

5. The method for map modification of claim 4, wherein generating the target virtual boundary segment based on the first endpoint, the dragging trajectory and the second endpoint comprises:
forming the target virtual boundary segment based on a movement trajectory indicated by a movement operation instruction from the user for the first endpoint and/or the second endpoint, and the dragging trajectory.

6. The method for map modification of claim 3, wherein the target virtual boundary segment comprises N target virtual boundary segments; and the method further comprises:
obtaining N dragging trajectories from the user starting from any of the endpoints in the first virtual map, and forming N target virtual boundary segments based on the N dragging trajectories, wherein N is an integer greater than 0, and the N dragging trajectories are connected end to end.

7. The method for map modification of claim 3, further comprising:
detecting that the stroke selection instruction is terminated during a stroking process of the user, and forming a straight line between the first endpoint and the second endpoint according to the stroke selection instruction; and
determining that the straight line and the unmodified boundary segment form the target virtual boundary segment in response to a confirmation instruction from the user.

8. The method for map modification of claim 6, further comprising:
before obtaining the M-th dragging trajectory of the user in the first virtual map, determining a boundary attribute of the M-th target virtual boundary segment corresponding to the M-th dragging trajectory in response to a boundary attribute selection instruction from the user for the M-th dragging trajectory, wherein M is any integer from 1 to N.

9. The method for map modification of claim 1, further comprising one of:
in response to an operation instruction from the user, aligning and overlapping the coordinate positions of a displayed first boundary map and a background map to obtain the first virtual map; wherein the first boundary map comprises first virtual boundary primitives representing the first virtual boundary; the background map comprises sketch primitives; a positional relationship between the sketch primitives and first virtual boundary primitives in the first virtual map is used to provide a visual reference; and
determining the first boundary map as the first virtual map in response to an operation instruction from the user.

10. The method for map modification of claim 9, wherein in response to the operation instruction from the user, aligning and overlapping the coordinate positions of the displayed first boundary map and the background map to obtain the first virtual map comprises:
in response to an overlap display operation instruction from the user, displaying a plurality of map styles; and
in response to a selection instruction from the user for a target style among the plurality of map styles, aligning and overlapping the coordinate positions of the background map corresponding to the target style and the first virtual map to obtain the first virtual map.

11. The method for map modification of claim 9, further comprising:
after in response to the operation instruction from the user, aligning and overlapping the coordinate positions of the displayed first boundary map and the background map to obtain the first virtual map, if the first virtual boundary in the first virtual map is not completely covered by the sketch primitives, performing a first prompt to the user after jumping to a predetermined interface; wherein the first prompt is used to remind the user to refer to the sketch primitives when modifying the first virtual boundary.

12. The method for map modification of claim 11, further comprising:
if an area of the first virtual boundary in the first virtual map covering the sketch primitives is less than a predetermined ratio, performing a first prompt to the user after jumping to the predetermined interface.

13. The method for map modification of claim 4, further comprising:
in response to the stroke selection instruction, enlarging and displaying a first enlarged view of a first operation area at a first preset position; wherein the first operation area is a preset range area corresponding to an operation point of the stroke selection instruction on the first virtual boundary; and the first enlarged view comprises a segment of the first virtual boundary stroked by the stroke selection instruction; and
in response to the dragging operation instruction, enlarging and displaying a second enlarged view of a second operation area at a second preset position; wherein the second operation area is a preset range area corresponding to a dragging trajectory point of the dragging operation instruction; and the second enlarged view comprises a corresponding dragging trajectory.

14. The method for map modification of claim 3, further comprising:
in response to the stroke selection instruction from the user for a boundary segment of mixed attributes in the first virtual map, determining the boundary segment of mixed attributes as the boundary segment to be modified; wherein there are a plurality of positional relationships the boundary segment of mixed attributes and the intelligent mobile device.

15. The method for map modification of claim 3, further comprising:
in response to an attribute type selection instruction from the user for the boundary segment to be modified, displaying a plurality of attribute type styles; and
in response to a selection instruction from the user for a target attribute style among the a plurality of attribute type styles, modifying the boundary attribute of the boundary segment to be modified to a target boundary attribute corresponding to the target attribute style.

16. The method for map modification of claim 3, further comprising:
if it is detected that the second virtual boundary in the second virtual map is abnormal, performing a second prompt to the user.

17. The method for map modification of claim 16, wherein if it is detected that the second virtual boundary in the second virtual map is abnormal, performing a second prompt to the user, comprises any one of:
if it is detected that the N target virtual boundary segments in the second virtual boundary self-intersect, performing the second prompt to the user; or
if it is detected that the second virtual boundary intersects a preset functional area, performing the second prompt to the user.

18. A method for device control, applied to an intelligent mobile device, comprising:
obtaining a second virtual map, and working based on the second virtual map;
wherein the second virtual map is determined by a client, in response to a selection instruction from a user for a displayed first virtual map, selecting endpoints of a boundary segment to be modified, and forming a target virtual boundary segment and an unmodified boundary segment based on the endpoints and a dragging operation instruction from the user between the endpoints; the unmodified boundary segment is a part of the first virtual boundary other than the boundary to be modified; the first virtual map comprises a first virtual boundary, and an area enclosed by the first virtual boundary is used to indicate a working area of the intelligent mobile device.

19. An apparatus for map modification, applied to a client, comprising:
a memory for storing a computer program; and
a processor for executing the computer program stored in the memory to:
display a first virtual map; wherein the first virtual map comprises a first virtual boundary, and an area enclosed by the first virtual boundary is used to indicate a working area of an intelligent mobile device;
in response to a selection instruction from a user, determine endpoints of a boundary segment to be modified in the first virtual boundary;
form a target virtual boundary segment based on the endpoints and a dragging operation instruction from the user between the endpoints; and
determine, based on the target virtual boundary segment and an unmodified boundary segment, a modified second virtual map for display; wherein the unmodified boundary segment is a part of the first virtual boundary other than the boundary to be modified.

20. The apparatus for map modification of claim 19, wherein
the first virtual map further comprises sketch primitives, position information of the sketch primitives is obtained by scanning when a scanning device works within a range of 0-20 m above the ground in the working area, and a positional relationship between the sketch primitives and first virtual boundary primitives in the first virtual map is used to provide a visual reference.
